(19) United States
(12) Patent Application Publication
(10) Pub. No.: US 2016/0357915 A1
(43) Pub. Date: Dec. 8, 2016

(54) SYSTEM AND METHOD FOR ANALYZING DISTRIBUTED ELECTRONIC MEDICAL RECORD DATA TO DETERMINE STANDARDS COMPLIANCE

(71) Applicant: Humana Inc., Louisville, KY (US)

(72) Inventors: George Morris, Los Gatos, CA (US); Mark Willard, San Jose, CA (US)

(21) Appl. No.: 14/491,260

(22) Filed: Sep. 19, 2014

Related U.S. Application Data
(63) Continuation-in-part of application No. 14/217,175, filed on Mar. 17, 2014.
Application No. 14/217,175 is a continuation-in-part of application No. 13/587,728, filed on Aug. 16, 2012.
Application No. 13/587,728 is a continuation-in-part of application No. 12/893,384, filed on Sep. 29, 2010.
Application No. 12/893,384 is a continuation-in-part of application No. 12/893,384, filed on Sep. 29, 2010.
(60) Provisional application No. 61/799,198, filed on Mar. 15, 2013.

(51) Int. Cl. G06F 19/00

(52) U.S. Cl. CPC G06F 19/322

(57) ABSTRACT

The present invention is a system and method for the analysis of the compliance to medical care standards of patient care data retrieved from a plurality of electronic medical records storage systems where the electronic medical records systems are not in direct communication with each other. The system and method is enabled through the use of a plurality of electronic interface appliance devices, each in communication with one of the plurality of electronic medical records systems and also in communication with a medical analytics engine and medical care standards data. The system and method configured so that the retrieval and analysis of patient care data may be performed on a real-time basis to allow a care provider to receive the compliance analysis results during an interaction with a patient.

### CROSS-REFERENCE TO RELATED APPLICATIONS

This application also makes use of technology more thoroughly defined in U.S. patent application Ser. No. 12/893,384, entitled ELECTRONIC MEDICAL RECORD EXCHANGE SYSTEM, Ser. No. 13/587,728, entitled APPARATUS AND METHOD FOR MEDICAL INFORMATION EXCHANGE CONSENT POLICY DATA FILTERING, and Ser. No. 14/217,175, entitled SYSTEM FOR UNITARY DISPLAY OF PATIENT DATA FROM MULTIPLE CARE PROVIDERS, which are also hereby incorporated by reference in their entirety herein.

### TECHNICAL FIELD

Exemplary embodiments of the present invention relate generally to electronic medical records and in particular, a system and method for analyzing patient records comprising data from multiple service providers in multiple formats. Embodiments of the invention may also present the analyzed data to a user of the invention in a manner that assists the user to identify the most impactful data.

### BACKGROUND AND SUMMARY OF THE INVENTION

Prior to electronic medical record (EMR) systems, medical records were often kept in paper format in a physician's office or hospital. Folders were maintained for each patient listing patient symptoms, diagnoses, and prescribed drugs or treatments. These paper-based records systems frequently consumed large amounts of storage space, were not easily archived, and were not easily searchable. The introduction of EMR systems allowed health care providers to gather and store patient medical records in an electronic format that was rudimentarily searchable, able to be backed-up electronically, and which required much less space than a paper-based record system. The ability to retrieve and search electronic medical records generally improved the ability of health care providers to provide care to their patients. As technology advanced and the cost for such technology decreased, EMR systems became more commonplace in even small medical care providers.

Despite their many benefits, EMR systems are not without their shortcomings. Even with reduced system costs, EMR systems may be costly to implement, particularly when capital costs, training costs, maintenance costs, and data conversion costs are taken into consideration. Even after implementing an EMR system, a care provider's patient records may still have significant shortcomings. One such shortcoming may result from there being multiple providers of EMR systems and few accepted standards for storing and communicating patient data. As a result, EMR systems often are implemented as separate and incompatible systems using different data formats, between care providers. An undesirable result of such separation and incompatibility may be that patents seeking care from multiple care providers may be forced to repeat the same information to each care provider during an initial visit to that provider. In addition to patient inconvenience, another result may be that, because of errors, omissions, and changing conditions, individual EMR systems may not contain consistent patient data across the various care providers. Inconsistencies may also result from the use of different identification and coding standards among the various EMR systems. For example, a first EMR system may use the Systemized Nomenclature of Medicine (SNOMED) standard while a second EMR system may use one of the various versions of the International Classification of Diseases (ICD-9 and ICD-10). Standards also exist for medications (RxNorm).

In addition to inconsistent records across different EMR systems, each system may utilize a different method and format of presenting the data recorded within the EMR system to physicians and other health care providers. Thus, in the event that a second care provider is able to access a patent's record on a first care provider's EMR system, that second care provider may be faced with an unfamiliar means of presenting a patient's information or may not be able to efficiently navigate the user interface of the EMR system in order to efficiently access the information needed. Simply combining the records of each care provider may result in duplicate or conflicting data for a given patient, resulting inefficient and potentially dangerous delivery of patient care.

To illustrate the potential problem, an example patient may be diagnosed with high blood pressure at a primary care physician and fail to relate this information during a subsequent visit to a second care provider. As a result of not having access to the information or having difficulty navigating an unfamiliar user interface, the second care provider may not realize that the patient has been diagnosed with high blood pressure, and incorrectly interpret the patient's subsequent health complaints. This may result in less effective care or even dangerous misdiagnoses or treatment.

What is needed is a system and method for standardizing the data format of the user interface across a plurality of EMR systems. Also needed is a system and method of removing duplicate data from the data presented from a plurality of EMR systems.

In addition to the system and method for standardization, a system and method is needed to present the data to physicians or other caregivers in a manner which does not require the physician or caregiver to search an accumulation of data that is not organized into formats easily interpreted by the viewer.

Also needed is a system and method for analyzing the patient health data present in the plurality of EMR systems and presenting the results of such analysis to care providers in real-time or near real-time. Preferably such a system and method will enable a care provider to receive and act on the analysis while the patient is still present at the care provider's location.

As health care providers and governmental agencies seek to improve the care provided to patients while also controlling costs, various heath care standards have been implemented. Such standards frequently measure the effectiveness of patient care for patients subdivided into various patient heath conditions and characteristics. Examples of characteristics may be age, sex, a patient's marital status, a patient's occupation, a patient's lifestyle factors such as exercise, smoking, and patient's family history as may be relevant to indicate an increased likelihood of developing certain diseases. Care providers may then be incentivized by their effectiveness ratings. What is needed is a system and method for care providers to monitor their effectiveness in such a manner as to allow care providers to adjust their care practices by location, individual care provider, or patient in order to optimize the delivery of care in order to best comply with the applicable health standards.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a diagram of a known implementation of a plurality of EMR systems;

FIG. 2 is a diagram of an exemplary embodiment of the invention implemented with a plurality of EMR systems;

FIG. 3 is a block diagram of an embodiment of an interface appliance device used to implement an embodiment of the invention;

FIG. 4 is a flow chart illustrated steps taken in an embodiment of the invention;

FIG. 5 is an illustration of a user interface used in an embodiment of the invention;

FIGS. 6a and 6b are illustrations of a user interface used in an embodiment of the invention;

FIG. 7 is a representation of a portion of a user interface used in an embodiment of the invention;

FIG. 8 is a representation of a portion of a user interface used in an embodiment of the invention;

FIG. 9 is an illustration of a user interface comprising medical record data presented in a timeline format used in an embodiment of the invention;

FIG. 10 is a representation of a user interface from an embodiment of the invention;

FIG. 11 is a representation of a user interface used in an embodiment of the invention showing a care provider location selection input screen;

FIG. 12 is a representation of a user interface used in an embodiment of the invention showing a user selection input screen;

FIG. 13 is a representation of a user interface used in an embodiment of the invention;

FIG. 14 is a representation of a user interface used in an embodiment of the invention;

FIG. 15 is a representation of a user interface used in an embodiment of the invention;

FIG. 16 is a representation of a user interface used in an embodiment of the invention illustrating a signature capture using a touch screen interface;

FIG. 17 is a representation of a user interface used in an embodiment of the invention;

FIG. 18 is a representation of a user interface used in an embodiment of the invention;

FIG. 19 is a representation of a user interface used in an embodiment of the invention;

FIG. 20 is a representation of a user interface used in an embodiment of the invention;

FIG. 21 is a representation of a user interface used in an embodiment of the invention;

FIG. 22 is a representation of a user interface used in an embodiment of the invention;

FIG. 23 is a representation of a user interface used in an embodiment of the invention;

FIG. 24 is a representation of a user interface used in an embodiment of the invention illustrating an input screen for use in adding patient data to an EMR system;

FIG. 25 is a diagram of an exemplary embodiment of the invention implemented with a plurality of EMR systems and including a medical analytics engine;

FIG. 26 is a flow chart of the steps taken in an embodiment of the invention;

FIGS. 27a-27c are illustrations of user interfaced from an embodiment of the invention;

FIG. 28 is an illustration of a user interface from an embodiment of the invention which illustrates a category of information that has been expanded to allow a user to view more information; and

FIG. 29 is a flow chart of the steps taken in an embodiment of the invention.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions may be omitted for clarity and conciseness.

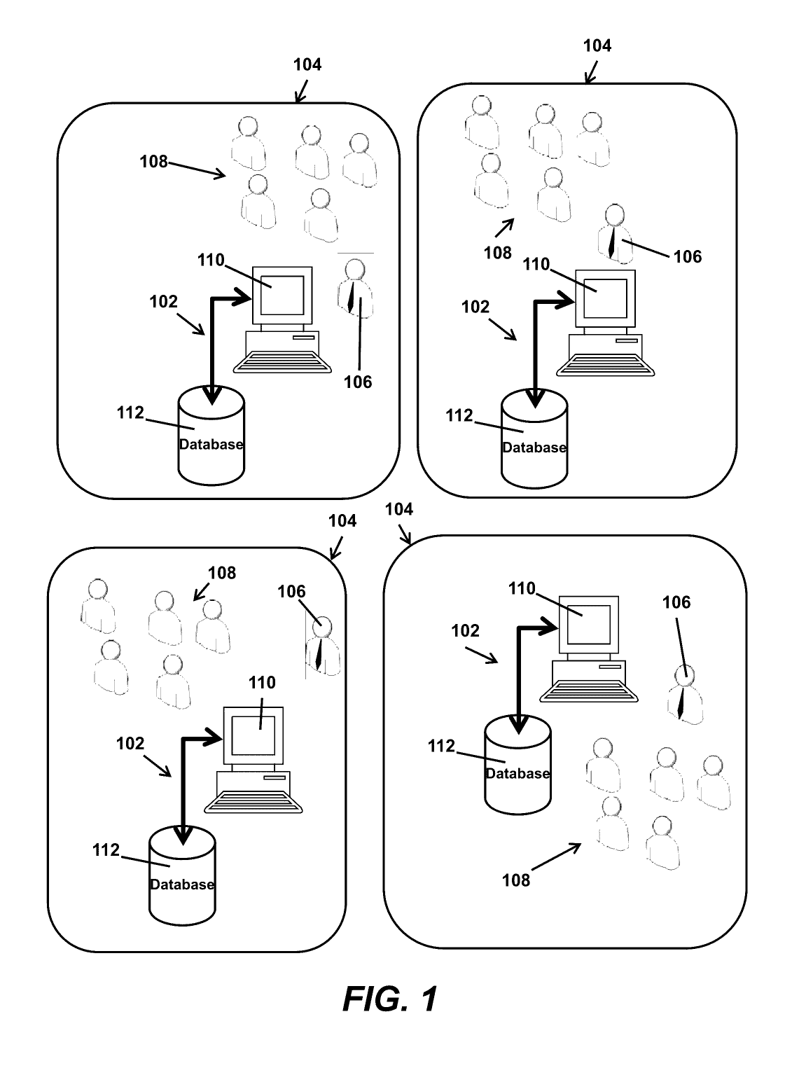

FIG. 1 is a representation of a known embodiment comprised of a plurality of EMR systems. As is illustrated, EMR systems 102 are typically associated with a healthcare service provider 104; here represented by an EMR system 102, a physician 106, and a plurality of patients 108. Important to note is the fact that frequently a physician 106 may have an affiliation or other relationship with more than one healthcare service providers 104. As a result, the physician may have a need to access a patient's records using the EMR systems of several service providers 104. As is illustrated, an EMR system 102 may comprise a computerized device 110 in communication with a database 112 comprising patient records. As may be noted in the known embodiment illustrated in FIG. 1, each computer device 110 may be isolated from other such devices. As a result, there is no convenient way for a physician to access electronic medical records located at a service provider using a different EMR system than that EMR system being used by the physician.

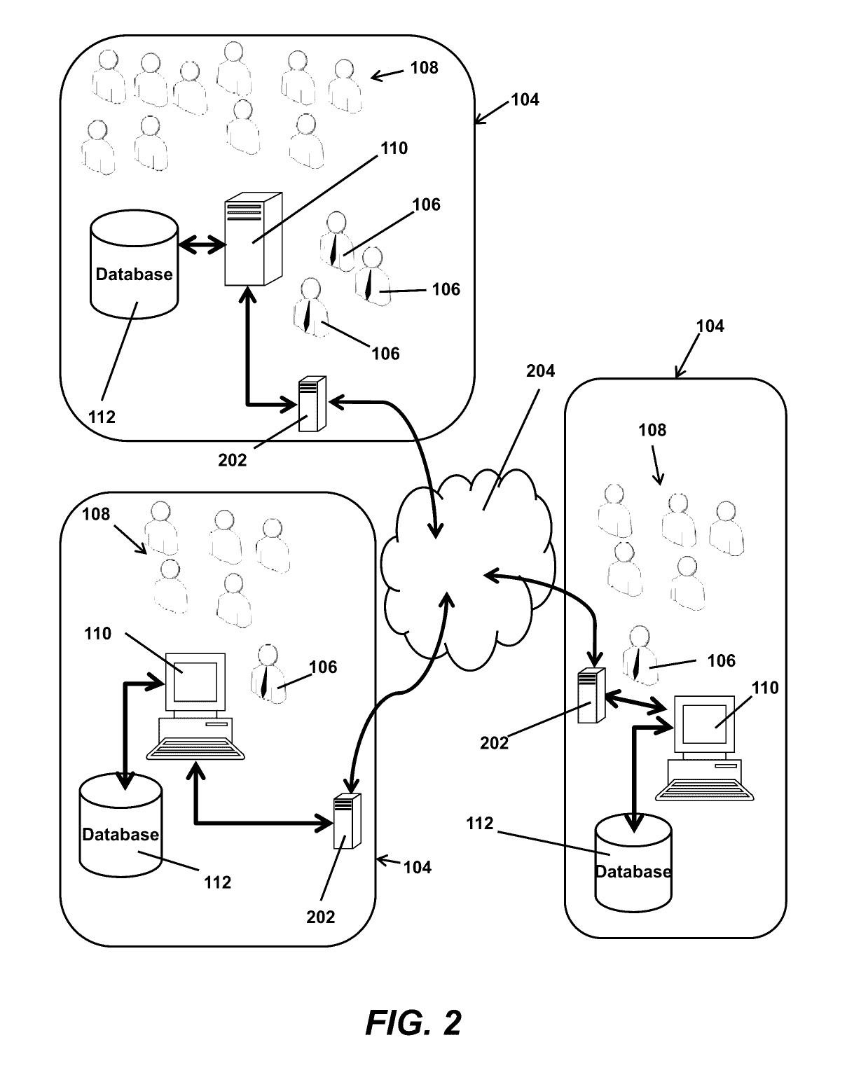

FIG. 2 is an illustration of a plurality of EMR systems that have implemented an embodiment of the invention. As shown, each healthcare service provider location 104 comprises an EMR system, which is itself comprised of a computerized device 110, and a database 112. As with currently known embodiments, each healthcare service provider location 104 may have patients 108 and physicians 106 which respectively seek and provide care services. In the illustrated embodiment of the invention, an interface appliance device 202 is in communication with each EMR system. In such an embodiment, the interface appliance device 202 may also be in communication with other interface appliance devices 202 via a wide area network 204. A common example of such a wide area network is the internet. Other examples of wide area networks may include, without limitation, proprietary wide area networks, cellular data networks, and dedicated medical data networks. The connection formed at each interface appliance device, as illustrated, may be referred to herein as a “node.” In embodiments of the invention, these nodes may be used to share and synchronize patient data between the EMR systems 102 located at the various care provider locations.

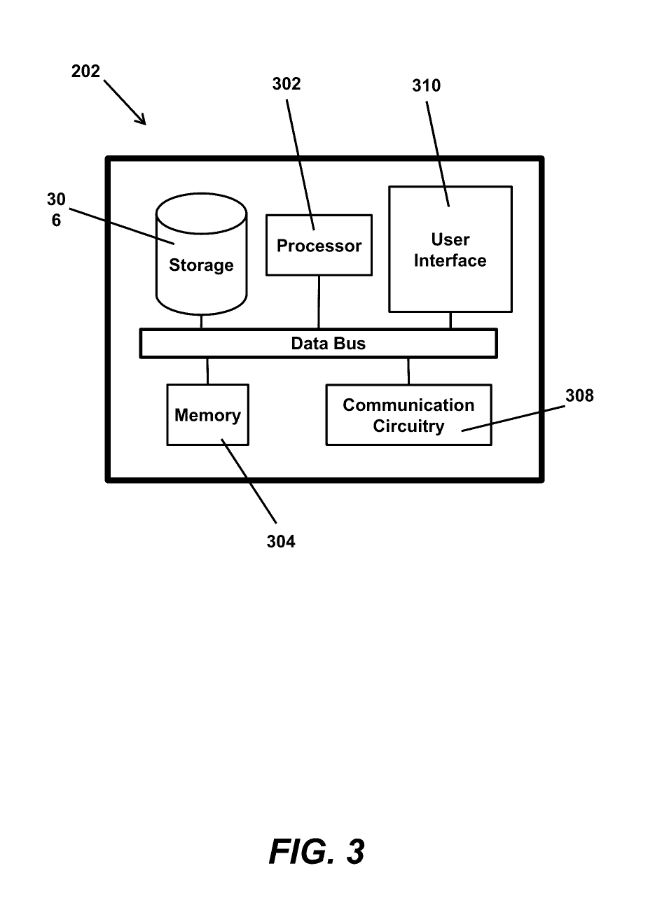

An embodiment of an interface appliance device 202 is illustrated in FIG. 3. As is shown, the interface appliance device may be comprised of a processor 302, an electronic memory 304, storage 306, communication interface circuitry 308, software instructions, and a user interface 310. Software instructions executed by the processor 302 may be stored in the electronic memory 304, storage 306, or may be retrieved from other locations via the communications circuitry 308. In certain embodiments of the invention, the user interface 310 may be integral to the interface appliance devices 202. An example of such an embodiment may be the use of a tablet computer functioning as the interface appliance device. In other embodiments of the invention, the user interface may be formed using well known devices such as display monitors and keyboard devices. In still other embodiments of the invention, the user interface may be formed using a personal computer, laptop computer, tablet computer, or other handheld computer device that may be a separate and distinct device from the interface appliance device 202. Such devices may be connected to the interface appliance 202 directly, or may be connected remotely through the use of computer networking technologies. In such remote connection embodiments, the user interface may be formed using web page or similar user interface techniques. In such embodiments, the interface appliance may function as a web server and the separate and distinct devices may interact with the web pages using a web browser. Embodiments with such separate devices may comprise software that performs portion of the inventive function where the software may be executed by the separate and distinct device. An example, without limitation, may be a tablet computer that executes an application program (an “App”) that forms a user display interface on the tablet computer. The App may send and receive information to and from one or more interface appliance devices. An advantage of the use of such an App may be increased data security and the flexibility to further customize the user interface presented by such an App without having to modify individual appliance devices. Such an embodiment may be also used to reduce the complexity of the software contained in the interface appliance device 202. An advantage of reducing the complexity of the interface appliance software may be the reduction or elimination of the need to regularly update the software. In such an embodiment, a care provider may transport their interface device from one EMR system to another without having to preconfigure each interface appliance device 202 to provide the desired user interface. In addition, such embodiments with separate devices may be configured to allow a plurality of such devices to be used to interface with the interface appliance device 202. These embodiments may allow interface appliance devices 202 to be assigned to a plurality of doctors and other caregivers. The communications circuitry 308 may be configured to provide the communicative connection to care provider EMR systems 102 as well as provide the connection to a wide area network 204 and ultimately to other interface appliance devices 202.

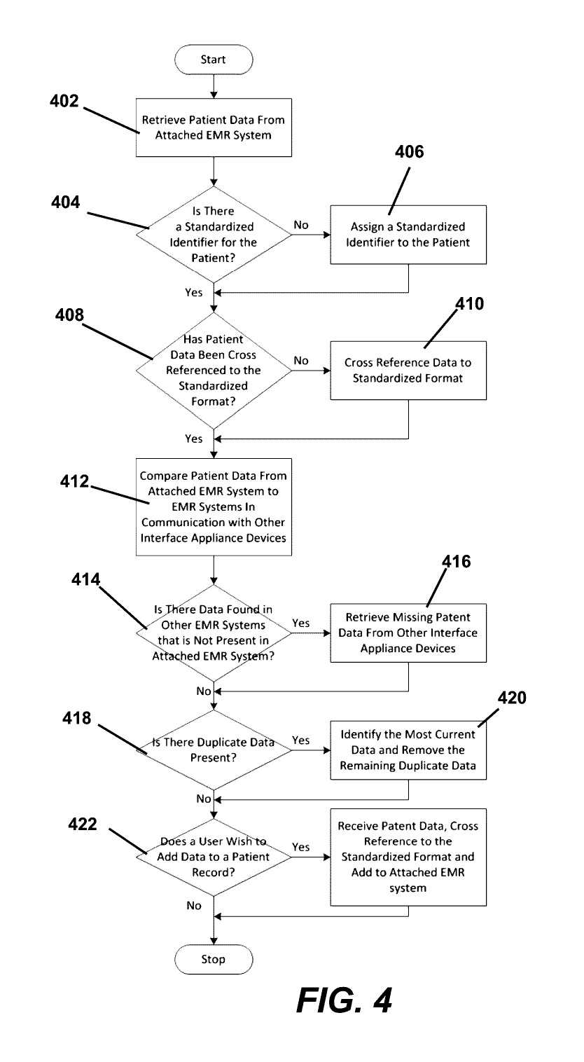

As was noted above, there may be a plurality of different EMR system types used by care providers to track and manage patient medical records. Each of these different EMR systems may store patient data in a format unique to the particular EMR system type. In order to provide the synchronization and sharing functions of the invention, patient data stored in a particular format may have to be converted to a standardized format used by each interface appliance device. An exemplary embodiment of the process of conversion is described in the flow chart of FIG. 4. In step 402, patient data may be retrieved from an attached EMR system. It should be noted that although the flowchart references patient data for a single patient, an embodiment of the invention may perform the illustrated steps for patient data found in the attached EMR system that represents a plurality of patients. To comply with privacy and other legal requirements, in certain embodiments one or more patients may be excluded from the process in order to avoid sharing their data with other EMR systems or analysis devices as described later herein. In order to manage a data sharing process across multiple EMR systems, each patient may have an identifier assigned by the interface appliance. In certain embodiments of the invention, such identifiers may be organized such that the original EMR system may be identified by analyzing the identifier. For example, an identifier may be a character string with 20 places such as A123456789B123456789. In an exemplary embodiment, the first four characters may represent the EMR system from which a patient's data was originally retrieved. For example, A1234 may represent hospital A, A1235 may represent clinic B, A1236 may represent urgent care provider C, and so on. If a patient is retrieved from an attached EMR system that does not have an identifier assigned, an embodiment may detect the lack of identifier 404, and assign such an identifier in step 406.

In order to share patent data across a variety of EMR systems, a standardized data cross reference may be used. In such an embodiment, a standard arrangement of patient identifiers may be established. Each identifier may represent a different piece of patient data and be organized such that a particular type of data may be identified globally throughout an embodiment of the invention. For example, a patient's blood pressure data measured on a first date may be associated with a first identifier; the patient's blood pressure taken on a second date may be associated with a second identifier, and so forth. By using a patient identifier and data identifiers, patient data from a first EMR system may be assigned to an appropriate set of identifiers which may be used by an interface appliance connected to a second EMR system to identify patient data present on one device that is not present on the other. In addition to differences in the arrangement of medical record data from one EMR system to another, the terms or codes used to describe diseases, treatments, and drugs may differ between the various EMR systems. For example, a first EMR system may utilize the SNOMED coding system, while a second EMR system may use a version of the ICD system such as version 9 (ICD-9). To be useful for a variety of care providers analysis systems, these terms and codes must be standardized. Embodiments of the invention may utilize an electronic medical terminology dictionary to perform such a standardization process. An example of such a dictionary is TermManager (Apelon, Inc., Hartford, Conn., www.apelon.com). Such a dictionary may be accessed by embodiments of the invention using a wide area network such as the Internet as illustrated in FIG. 2. In other embodiments, the dictionary may be implemented in the memory 304 or storage 306 of the interface appliance device 202. Embodiments of the invention may perform the cross reference and standardization (FIG. 4, step 410) as patient medical records data is retrieved from an EMR system in communication with an interface appliance 202. In a preferred embodiment of the invention, the cross referenced and standardized data is transitory in nature and persists only as long as a user or analysis system is accessing the data. The same may be true for data retrieved from other interface appliance devices 202.

Depending upon the embodiment of the invention, the data may be synchronized such that data not present on the EMR system in communication with a first interface appliance 202 but present on the EMR system in communication with a second interface 202 appliance may be copied to the memory 304 of the first interface appliance 202 from the second interface appliance 202. Such embodiments of the invention may identify data that is not present on an EMR system in communication with a first interface appliance 202 but is present on an EMR system in electronic communication with a second interface appliance 202. In such embodiments, the missing data may be presented to a user of the first interface appliance in a user interface such that the user interface may comprise data from the EMR system in communication with the first interface appliance as well as the EMR system in communication with the second interface appliance. Such a configuration may have the effect of making data temporarily available to the user of an interface appliance in communication with an EMR system without requiring that data be copied from one EMR system to another.

The process of identifying missing data may take place at predetermined intervals in some embodiments of the invention. However, in some embodiments of the invention, this process may take place at the time when a user identifies a patient for which to view or otherwise access EMR data. In step 408, an embodiment of the invention may determine if data in the attached EMR system has been referenced to a data identifier format. If not, the data may be cross referenced to such a format 410. In embodiments of the invention, when the patient data of the attached EMR system has been cross referenced to the data identifier format, the interface appliance may compare the patient data from the attached EMR system to data found in EMR systems in communication with other interface appliance devices 412. In step 414, the interface appliance may determine if there is data present on other EMR systems that is not found in the attached EMR system. If so, the data missing from the attached EMR system may be retrieved from the other EMR system 416 or systems for presentation to a health care provider or other user of an embodiment of the invention. As was noted above, in certain embodiments of the invention, the missing data may not be copied but instead presented to a user in an interface that comprises data from a plurality of EMR systems. In certain embodiments, the data may comprise an indication of its source to allow a user to identify the sources of patient data should additional information be required. In such embodiments, instead of adding missing data, the interface appliance 202 may assemble data obtained from various EMR systems into a user interface without permanently storing the combined data in a single database or memory. By not permanently storing data, such embodiments may avoid conditions in which several EMR systems exist, each with large numbers of duplicate records.

A potential difficulty encountered when synchronizing or otherwise making records available from multiple EMR systems is the existence of duplicate patient data records. Such records may create confusion, exaggerate the severity of a condition, or mask other data or patient conditions. An embodiment of the invention may review patient data contained in an EMR system with data present in a second EMR system, particularly after an EMR system is synchronized with other EMR system data, to identify duplicate data records 418. In certain embodiments of the invention, the most current of the duplicate records may be retained or marked as the record to be used in analysis and the remaining duplicate records removed 420 or otherwise marked as duplicates. Other embodiments of the invention may manage duplicate data by analyzing the source of the data to determine the most reliable data source, identify the completeness of the data record, or present the duplicate data to the user for analysis. Once such an analysis is performed, the record determined to be most reliable may be retained.

In addition to providing synchronization of data or an aggregate of data available across a plurality of EMR systems, embodiments of the invention may provide an alternate user interface to an EMR system. Such an interface may be generated by the interface appliance device 202. One advantage that such an interface may provide is a consistent user interface experience from one care provider location to another. As was noted above, physicians and other care providers frequently offer patient care from more than one care provider location. For example, a physician may be associated with a primary care location and also provide patient care at one or more hospitals using an embodiment of the invention. In such a situation, the physician may access patient data from either location using a familiar user interface, greatly reducing the learning curve and also reducing the likelihood of errors. A shortcoming of known EMR system is the chronologic nature of data presented by the EMR system. In such a chronological presentation, a care provider may not be made aware of critical patient characteristics because those characteristics may have been recorded at a point earlier in time than is displayed by the EMR system. In embodiments of the invention, the user interface presented to a care provider may gather patient characteristics and diagnoses from various points in time and present the data to a care provider such that critical data is position for easy access regardless of when the data was gathered.

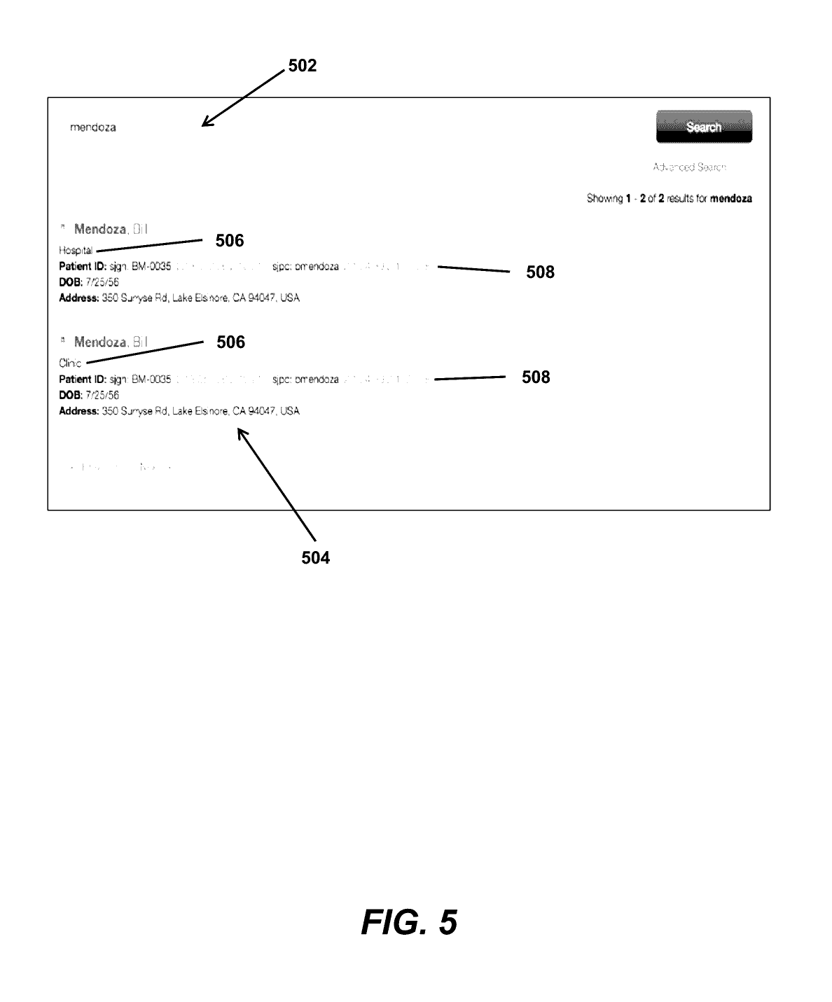

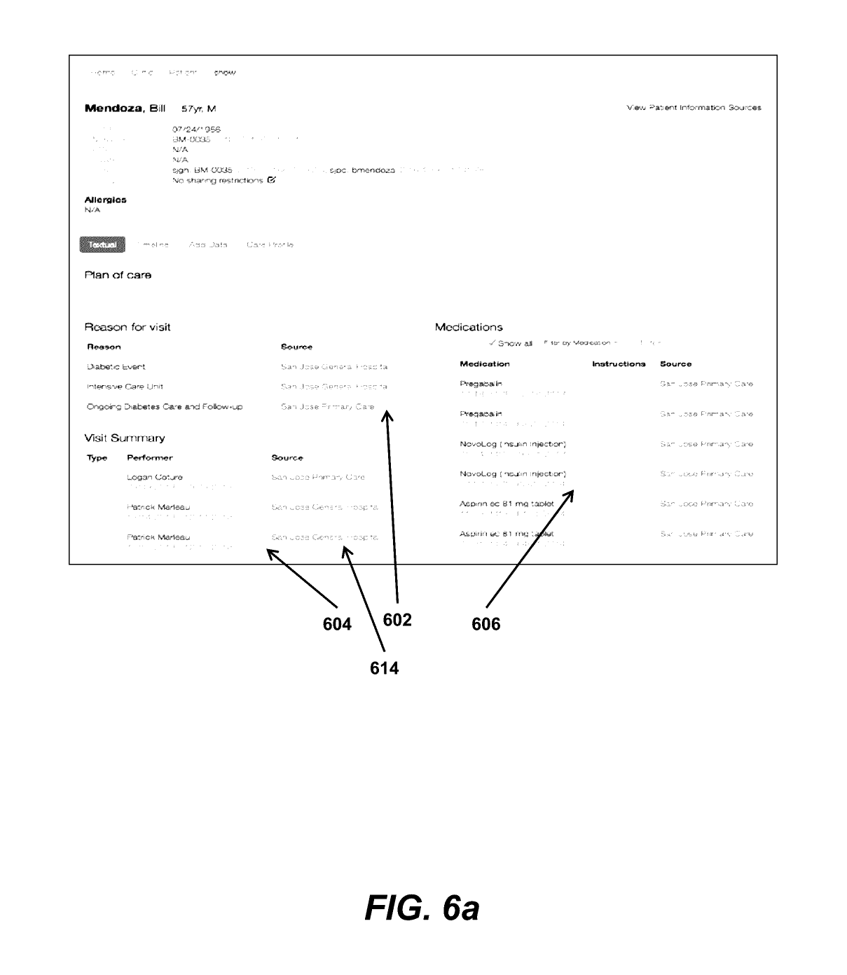

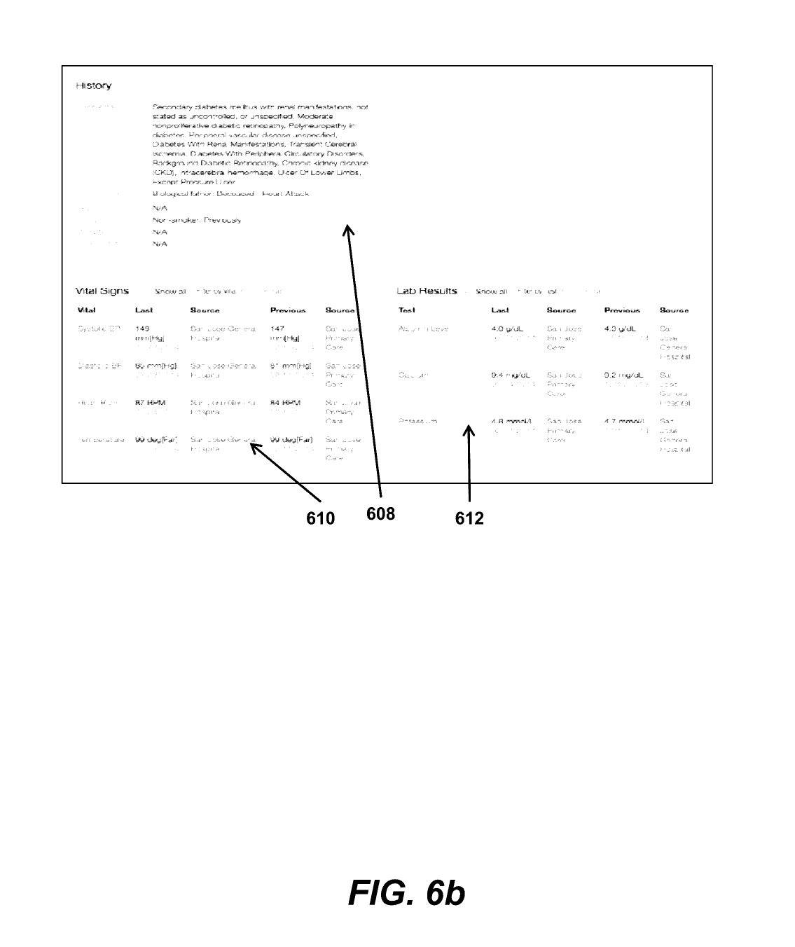

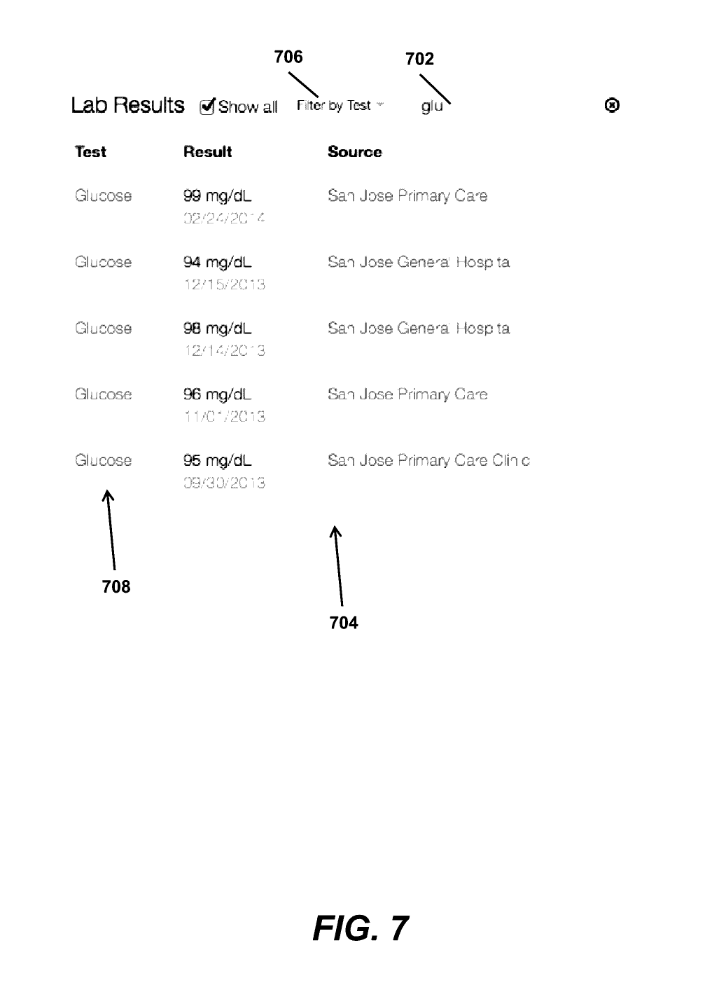

In certain embodiments of the invention, an interface generated by an interface appliance 202 may also make use of the connection to other nodes, as illustrated in FIG. 2, in order to allow a user to access data from the various EMR systems associated with each node. In a preferred embodiment of the invention, a user may be able to search for patient records across the various nodes in communication with a wide area network to which the user's interface appliance is connected. As is illustrated in the user interface of FIG. 5, a user may enter a patient search term 502 and instruct an embodiment of the invention to search the connected EMR systems for occurrences of the term. As is shown, such an embodiment of the invention may return occurrences of the search term from among the connected nodes 504. As is shown in the exemplary illustration, each returned record may have an indicator of the source of the record 506 and identifying information 508. If desired, a user may select one of the returned occurrences in order to view additional detail contained in the selected record. An example of such additional detail is illustrated in FIGS. 6a and 6b. As is shown, the additional detail may be displayed in a textual format with information arranged into various categories, examples of which may comprise reason for patient visit 602, visit summary 604, medications 606, patient history 608, patient vital signs 610, and lab results 612. As was noted earlier, the data displayed may be obtained from multiple EMR systems. An example of this is illustrated at 614 of FIG. 6a. As can be observed, the information presented for the reason for visit may be comprised of data obtained from different care providers. In the present example, data may have been obtained from multiple EMR systems and formatted as illustrated to allow the viewer to view a concise summary of data. In certain embodiments of the invention, data may extend beyond that which is conveniently displayed in each category display. In such a situation, embodiments of the invention may be configured to permit a user to scroll up or down to view additional data in a category. In addition, because patient records may be extensive, certain embodiments of the invention may be configured to allow a user to filter the data displayed. An example of such a filter is illustrated in the embodiment of the invention shown in FIG. 7. As is shown, the category of “Lab Results” has been filtered by the characters “glu” 702. The result of such a filtering action is illustrated at 704. In the example shown, the patient record was filtered by test type 706 to limit the results to “glucose” test results 708.

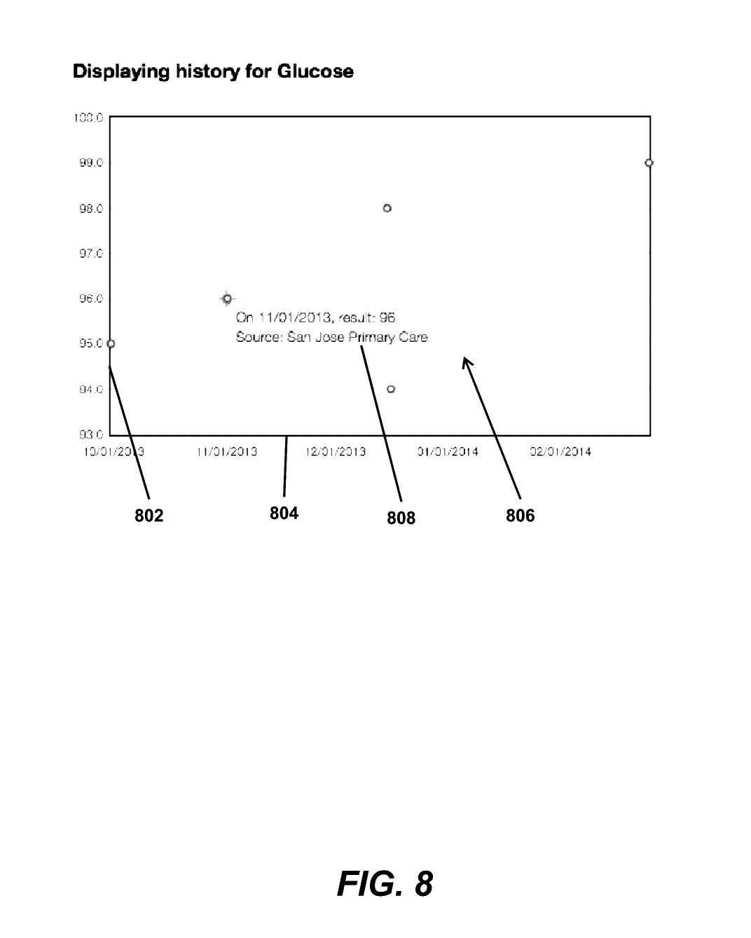

In addition to filtering a textual display, embodiments of the invention may be configured to display a graphical representation of a patient record. In such an embodiment, a user may select a particular record type and be presented with a graphical display of the record. An embodiment of such a display is illustrated in FIG. 8. As is shown, a patient history for glucose test results may be displayed with a test result axis 802 and a time axis 804. As is illustrated in the figure, a graphical representation may allow a user to identify a trend or fluctuation 806 in a particular test result. As with the textual display, a graphical display in an embodiment of the invention may display patient records from multiple EMR systems, allowing a user to obtain a greater perspective of a patient's health records than may be available from a single EMR system. As is illustrated, embodiments of the invention may be configured to enable a user to select a data point to view additional information 808.

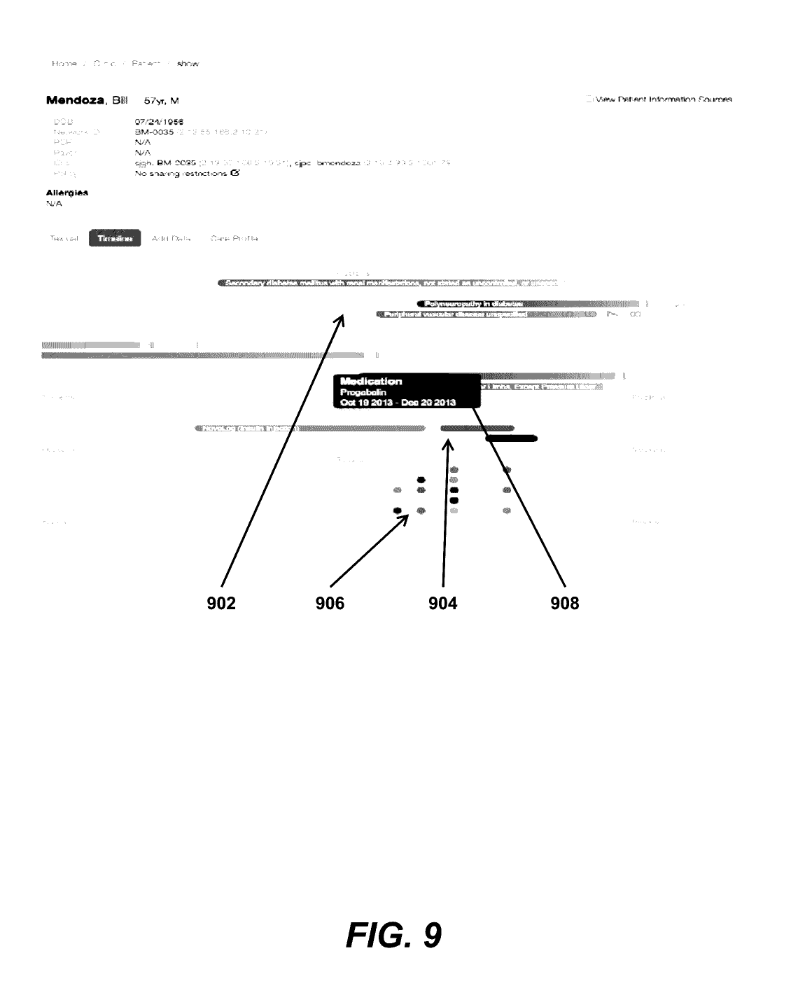

FIG. 9 illustrates an embodiment of the invention displaying a timeline of a patient's electronic medical records. Using such an embodiment of the invention that has various interface appliances 202 forming nodes as illustrated in FIG. 2, a user may configure a timeline display to include data from those nodes containing patient electronic medical records for a selected patient. As is shown in FIG. 9, a timeline may be configured to display a patient's medical records including, but not limited to, identified medical problems 902, prescribed medications 904, and test result 906. As is illustrated at 908, certain embodiments of the invention may be configured to display additional detail from a selected record. In the illustrated embodiment, a user has selected a medication displayed on the timeline and has been presented with additional detail about that medication.

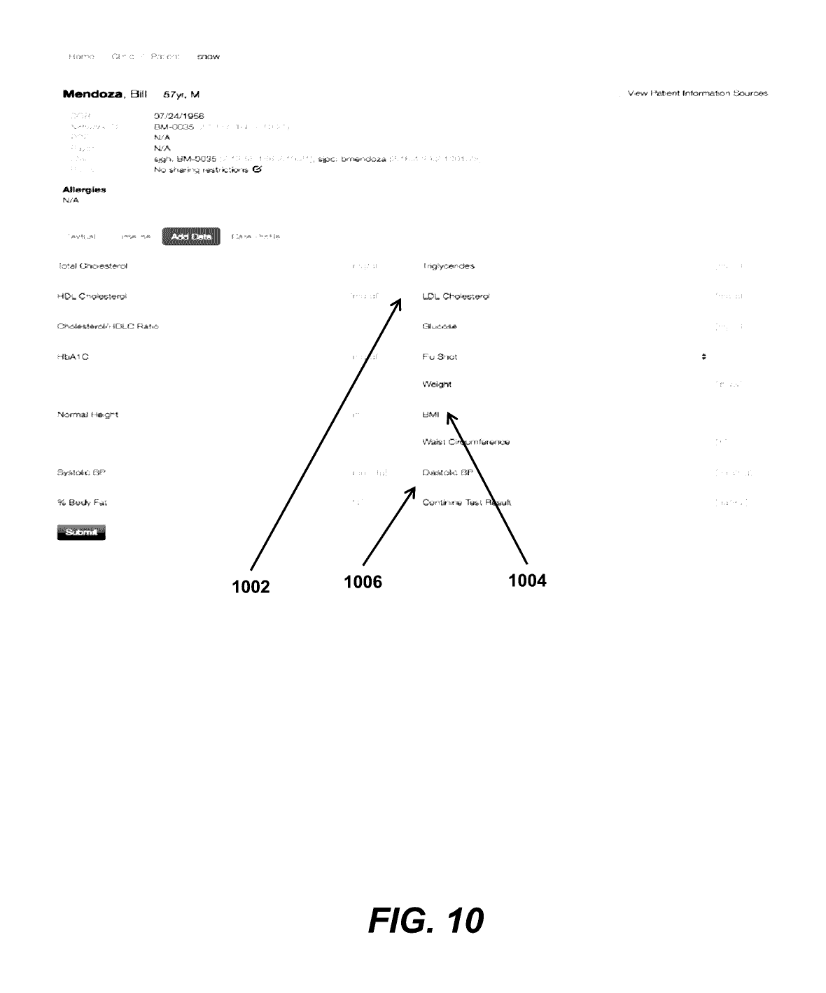

In order to provide a greater degree of functionality to an alternate user interface, embodiments of the invention may be configured to allow a user to enter patient information into one or more EMR systems. As is illustrated in step 422 of FIG. 4, an embodiment of the invention may identify a user's need to enter patient information and present a user interface to the user to enable information entry 424. An example of such a user interface is illustrated in FIG. 10. The user interface illustrated has entry fields for common patient characteristics and conditions measured during a visit to a care provider. For example, patient cholesterol information 1002, patient physical characteristics 1004, and blood pressure data 1006. The example illustrated may be used during a caregiver's interaction with a patient or may be used at a later time to capture health data measured during a patient visit. Certain embodiments of the invention may allow the user to select one or more EMR systems to receive the captured health data.

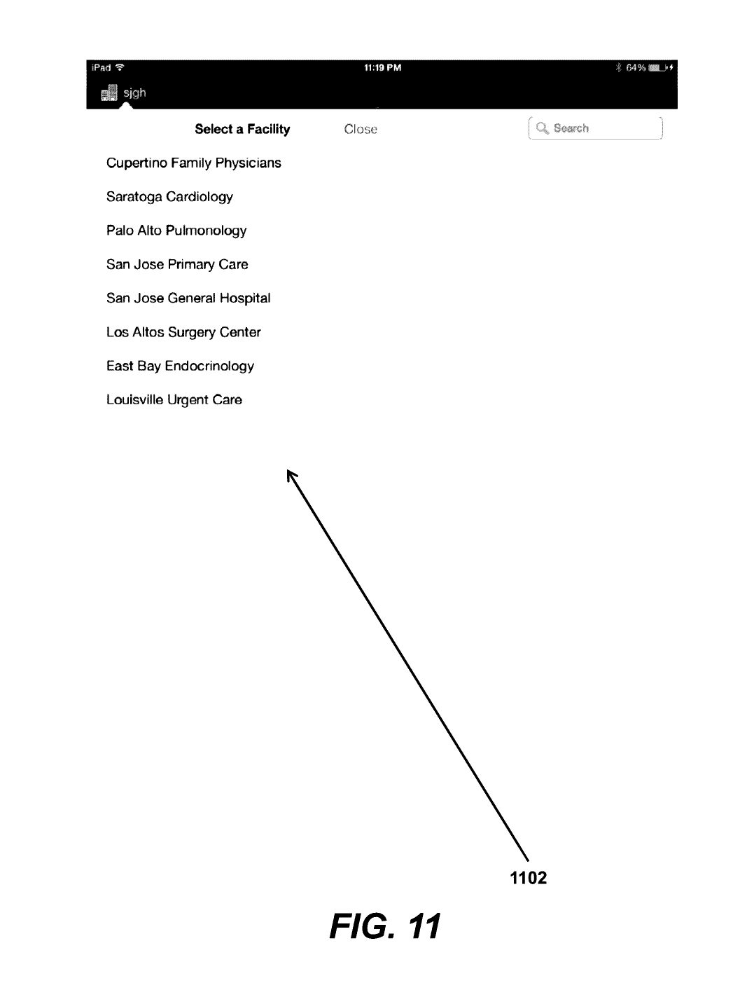

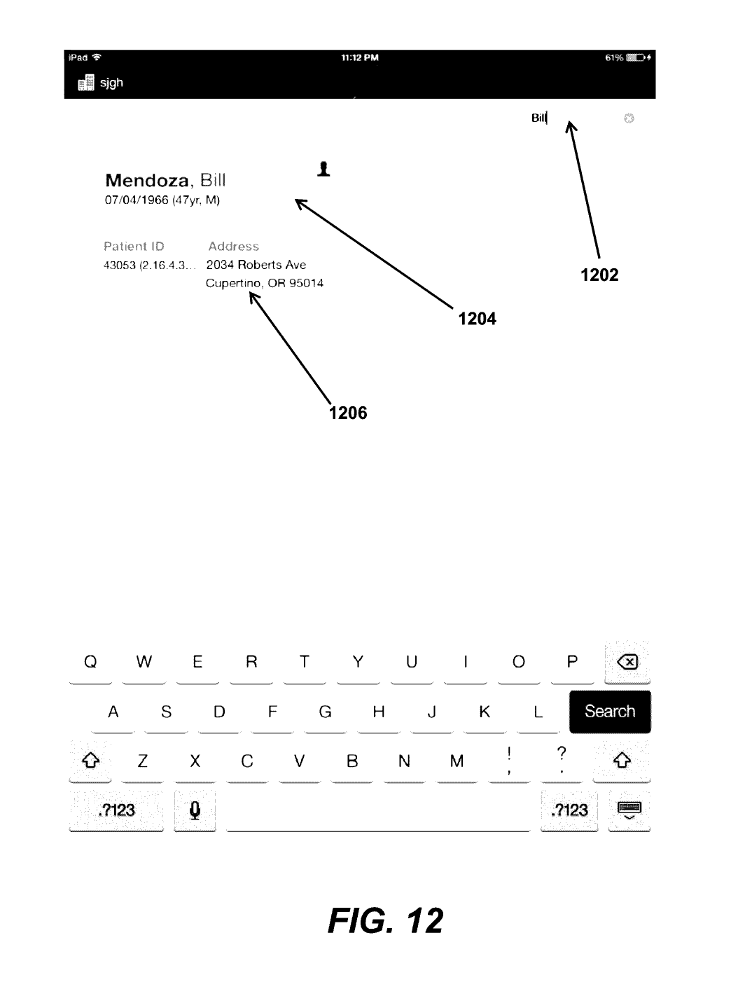

As was noted earlier herein, an alternate user interface to an EMR system may be generated by an interface appliance device 202. As was described, such an interface may be used to provide a common user interface, reducing the learning curve required of a physician or care provider, particularly in circumstances in which the physician or care provider provides care from a number of different locations. Another embodiment of such an interface may be optimized for the needs of a particular viewer. For instance, medical care providers that specialize in heart care may have a greater need to know the details of a patient's blood chemistry, blood pressure, and heart rate. Conversely, such a medical care provider may have a lesser need to know about past surgeries or other treatments unrelated to the circulatory system. In addition to, or in place of embodiments in which the user interface is generated by the interface appliance device 202, certain embodiments of the invention may be configured to allow a portable computer device to connect to one or more interface appliance devices electronically to receive patient health record information from the EMR system to which the interface appliance device is connected. In an embodiment which generates the user interface information within the interface appliance devices 202, software may support user interface images, data analysis, security, and user management. To reduce system requirements or increase flexibility of the user interface, an embodiment may be configured to move a majority of these functionalities to a portable computer device. An example of such a device, without limitation, may be a tablet computer. In addition, having a portion of the functionality included in a portable computer device may enable such devices to be configured specifically for the role of the user of such a device. For example, a technician or other general care provider may have access to a lesser amount of patient care data than would a physician. In such circumstances, the user interfaces presented may be less complex and be configured to allow the user to input or modify only certain patient characteristics. Other embodiments may be used to enable a fully customizable user interface that may be optimized for a particular care provider or care provider specialty. In such embodiments, a tablet computer may be equipped with software that enables a user to connect to a plurality of interface appliance devices 202. An example of such a user interface is illustrated in FIG. 11. As is shown, a user may log into the portable computer device and select a care provider location 1102 from which the user wishes to view and update patient information. As is illustrated in FIG. 12, a user of the portable computer device may search records in an EMR system that is associated with the care provider location selected in FIG. 11. In the illustrated example, a user has entered the search string of “Bill” in a search field 1202. Embodiments of the invention may search the records of the selected EMR system and return those records that match the entered search string. In the illustrated example, there is one name returned 1204. In an actual search, the number of returned names may be greater than what is illustrated in the figure. In such an instance, the user may select one of the returned names to obtain EMR system information about the selected name. As is shown, the returned name (or names) may provide additional information 1206 that the user may reference to confirm that a returned name is the patient for which EMR system records are desired.

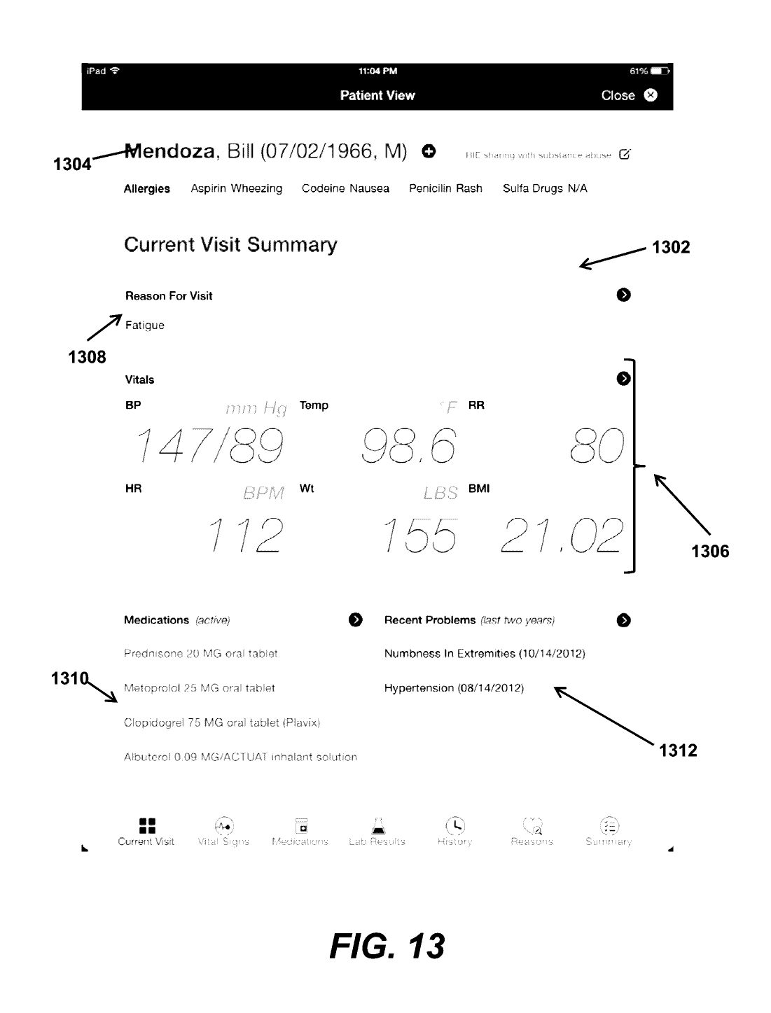

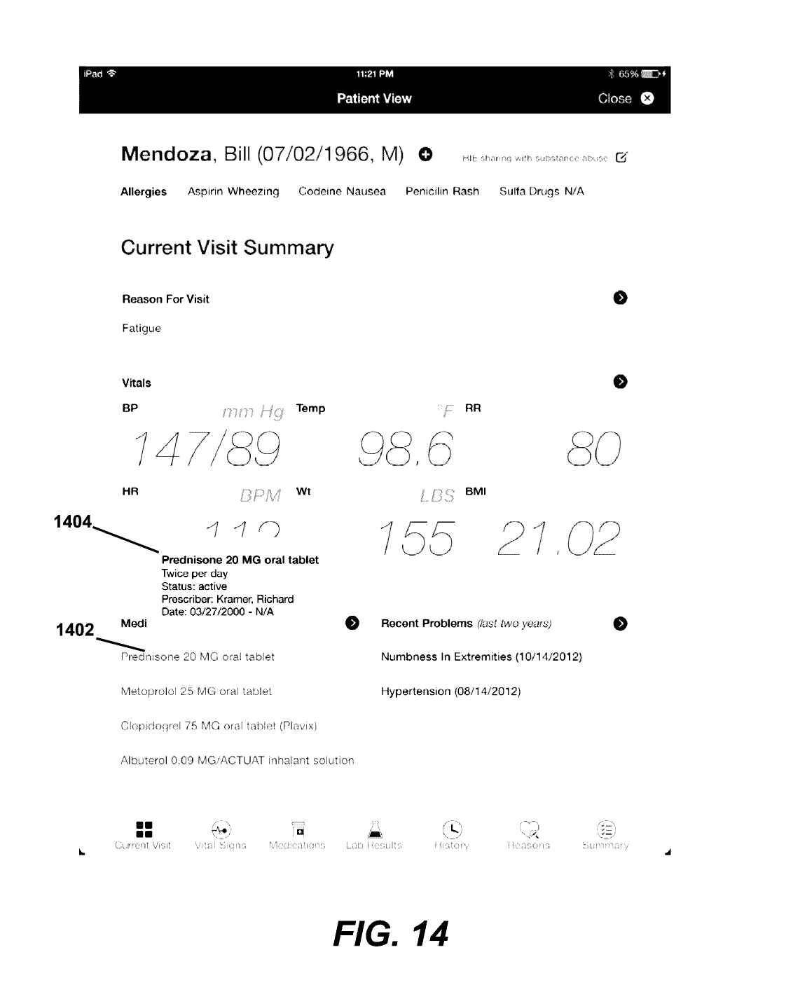

Once a name is selected, an embodiment of the invention may display patent information in order to assist the user in the provision of care to the selected patient. For instance, the user interface image illustrated in FIG. 13 represents a current visit summary 1302 for the selected patient 1304. Certain embodiments of the invention may present critical information in a preconfigured arrangement and location. For example, in the illustrated example, the patient's allergies are listed just below the patient name. Such an arrangement may help prevent a care provider from performing an action that could result in a dangerous allergic reaction to a drug or other treatment. In addition, as is shown at 1306, commonly recorded information may be displayed for quick review by a care provider. In the illustrated embodiment, blood pressure, temperature, respiration rate, heart rate, weight, and body mass index information are displayed prominently. Also displayed is information about the reason for the patient's visit 1308, current medications 1310, and recent patient health problems 1312. In certain embodiments of the invention, a care provider or physician may select certain elements of the displayed information to obtain additional information. An example of such an embodiment is displayed in FIG. 14. As is shown, a user has selected one of the medications listed 1402 and has received additional information about that medication 1404. Examples of such information may be frequency and amount of dosage, whether the prescription is currently active, the prescribing physician, and the date that the prescription was originally prescribed.

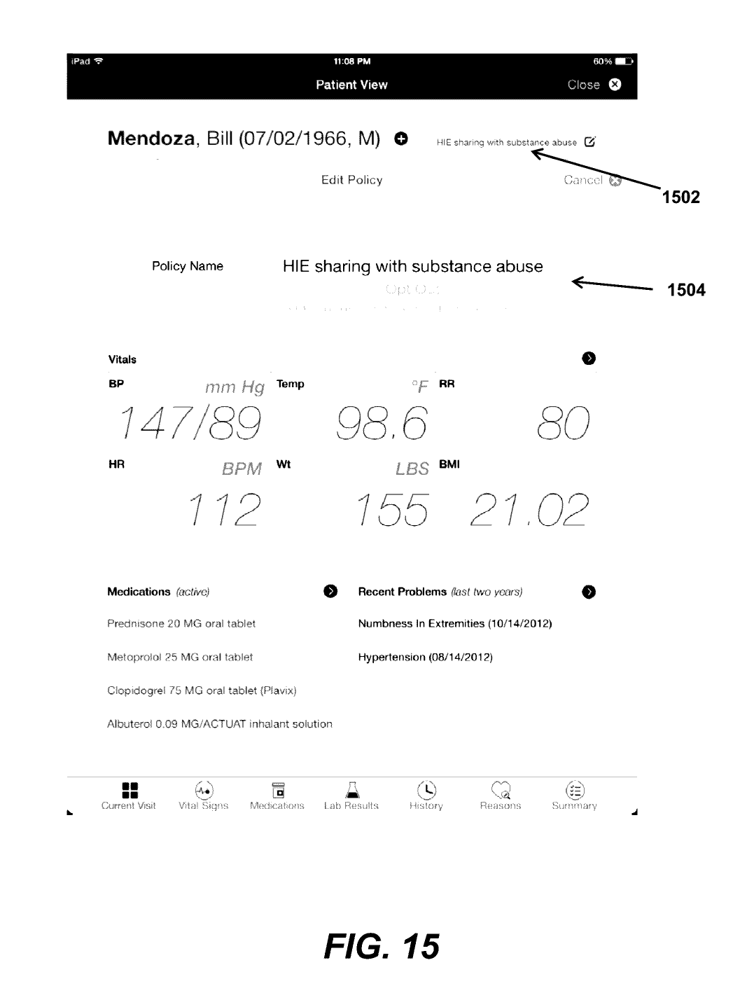

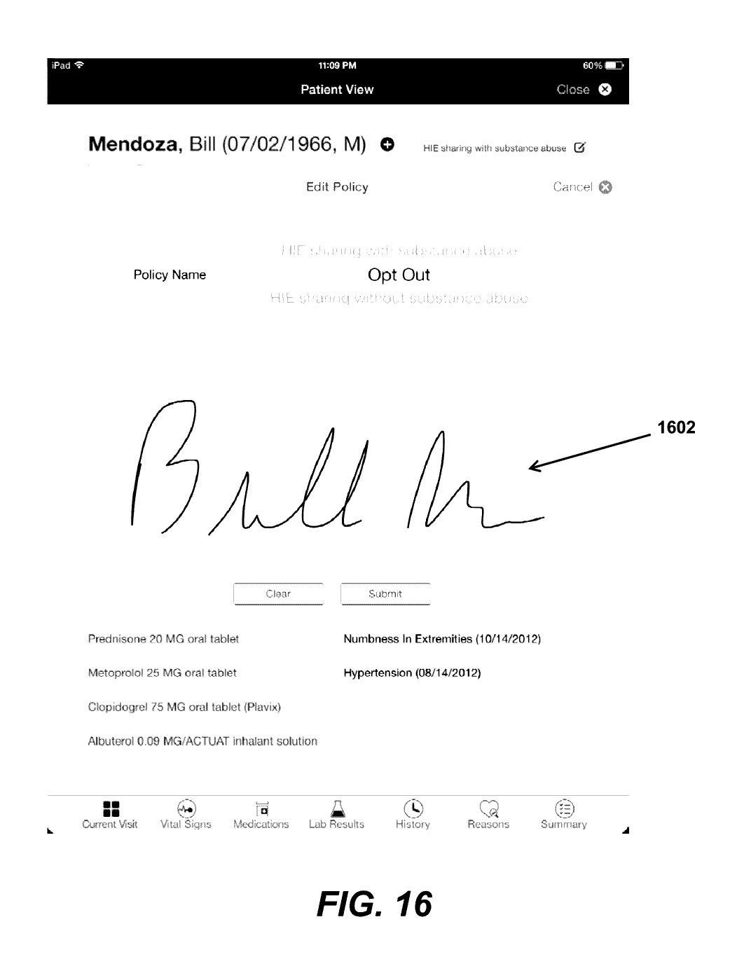

In embodiments of the invention in which a tablet computer is used to display patient information as illustrated in the preset figures, users may utilize touch sensitive user interfaces to interact with the displayed data. Such interactions may include the selection of certain information fields for additional information. In addition to viewing EMR system information, an embodiment of the invention may provide a user interface that permits a user to review or modify restriction or permissions related to sharing a patient's EMR system information. As is illustrated in FIG. 15, a user may select a control that displays the health record information sharing configuration for a patient 1502. The illustrated user interface shows that a patient has elected to share heath record information, including substance abuse information. Other options may comprise opting out of sharing or sharing health record information without the inclusion of certain information such as substance abuse information. In addition to displaying the information, some embodiments may also permit a user to edit the preferences for a selected patient 1504. In such an embodiment, a touch screen input may be used to receive a signature or other form of authentication. An example of such an embodiment is illustrated in FIG. 16, where a patient has “signed” using the touch sensitive interface 1602.

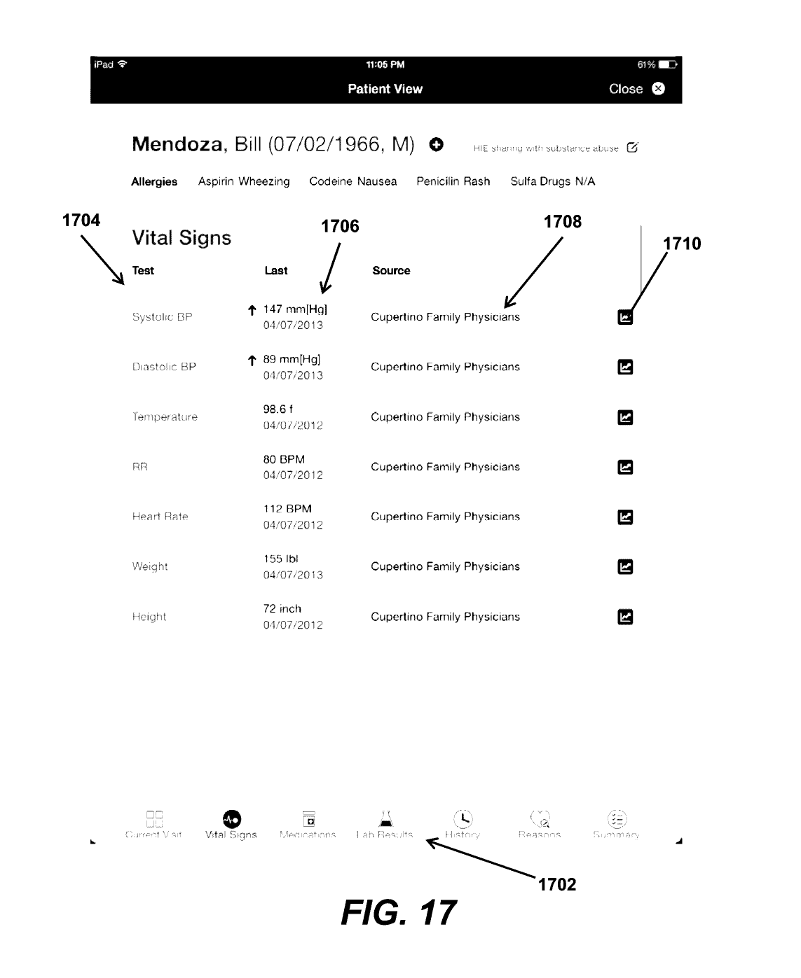

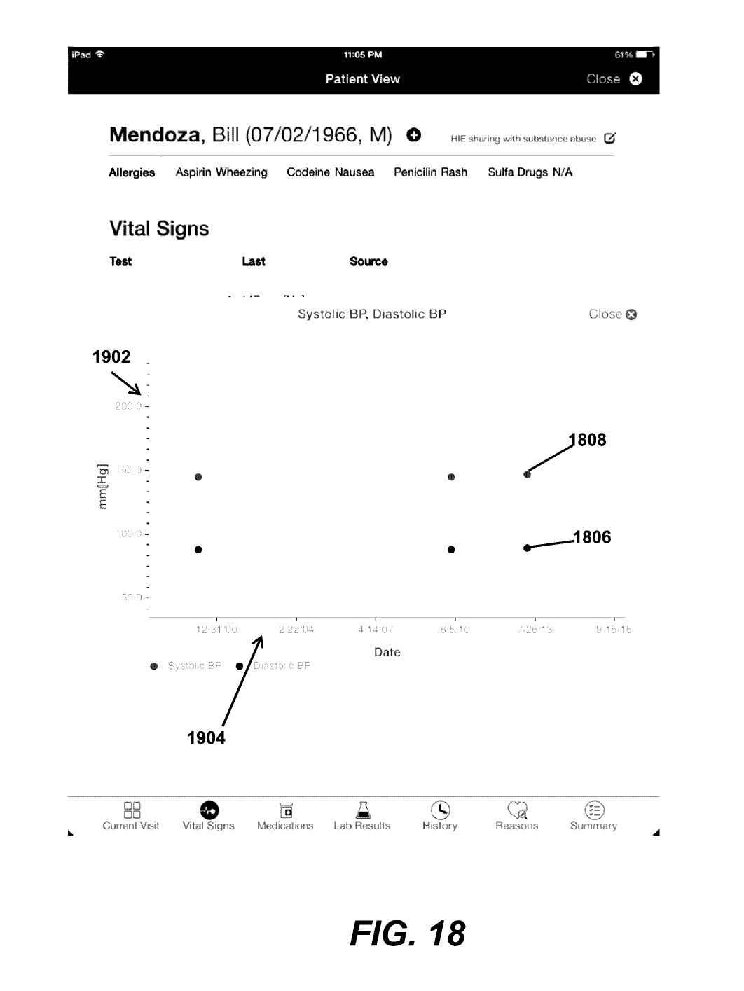

Another advantage of mobile computing devices is their size and portability which may allow a doctor or care provider to carry such a device into the examination or treatment area. As was described above, embodiments of the invention may be configured to provide data to a user from a plurality of EMR systems. Such configurations may also be applied to embodiments of the invention which utilize tablet computers as user interfaces. In addition to current visit information, such embodiments of the invention which make use of an application running on a mobile computing device may also present patient records data from a plurality of EMR systems in order to assist a physician or caregiver in his or her review of the patient's condition. Having the device, which may be used to access patient data from a plurality of EMR systems, available at the time of examination or treatment may provide significant advantages over known methods with regard to understanding a patient's complete medical history. As is illustrated in FIG. 17, a menu bar 1702 may be implemented to allow a user to quickly navigate from one display of information to another. In the screen image illustrated in FIG. 17, a user has selected the “vital signs” menu bar option. The result may be a display of vital signs that are listed in order of last recorded value. As is illustrated, a listing may include the type of test performed 1704, the reading and date 1706, and the source of the readings 1708. In certain embodiments of the invention, the vital signs display may be scrolled up or down to display additional vital sign information. As is frequently the case, vital signs taken alone may only indicate a portion of a patient's health status. A display of vital sign trends over time may help a physician or care provider identify changes in a patient's condition that may be indicative of potential health problems. Embodiments of the invention may have a control 1710, that when selected presents a graphical illustration of a patient's trends for one or more vital sign readings. FIG. 18 represents a display of blood pressure 1802 over time 1804. Frequently more than one vital sign is required by a care provider to understand a patient's health condition. Because of this, certain embodiments of the invention may anticipate this requirement and display multiple vital signs in the same graphic display. This is illustrated at 1806 and 1808, where systolic and diastolic blood pressures respectively, are displayed on the same display view. In certain embodiments of the invention, such combinations of vital signs may be preconfigured to best suit the physician or healthcare provider's anticipated needs. In addition, embodiments of the invention may retrieve data from the plurality of EMR systems to provide a more complete illustration of trends in a patient's condition. For instance, the example chart of FIG. 18 comprises test information retrieved from multiple EMR systems.

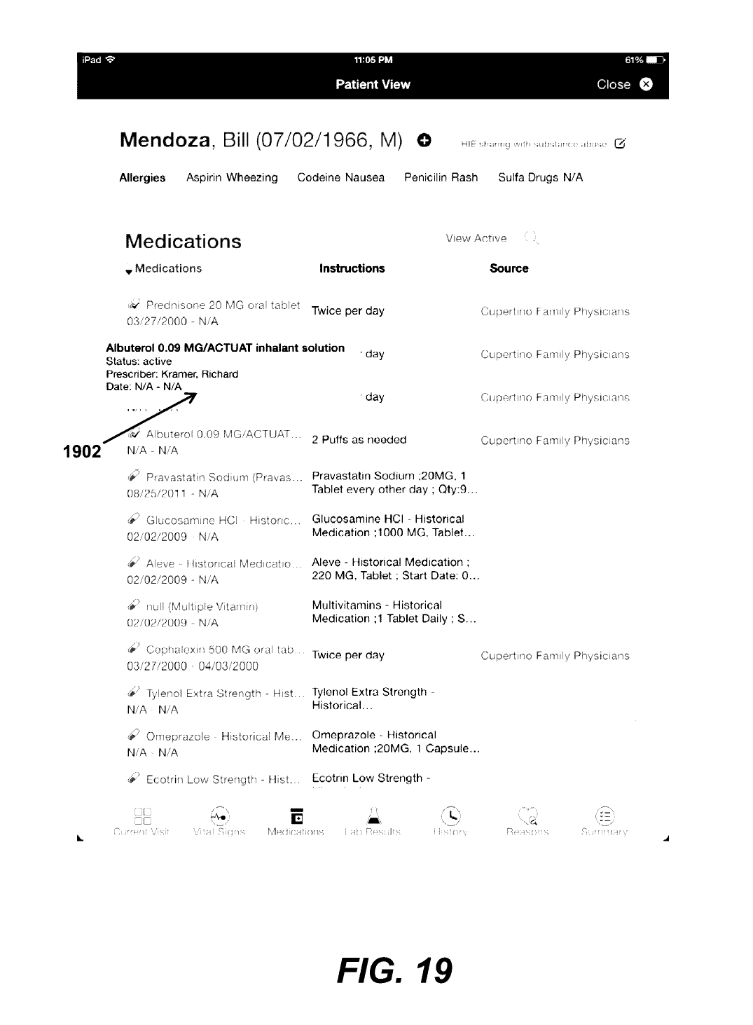

FIG. 19 illustrates a user interface comprising a listing of medications prescribed to a selected patient. Depending upon the number of medications prescribed and the amount of patient history contained in the EMR database(s) in communication with the interface appliance device 202, the listing may be configured to allow a user to scroll up or down to display additional medication data. As is illustrated, certain embodiments of the invention may allow a viewer to sort medication by name, prescription date, or other parameter in order to permit more efficient review by a user of the invention. In addition, in embodiments of the invention, a user may select a medication to view additional information about that medication as illustrated in FIG. 19 at 1902.

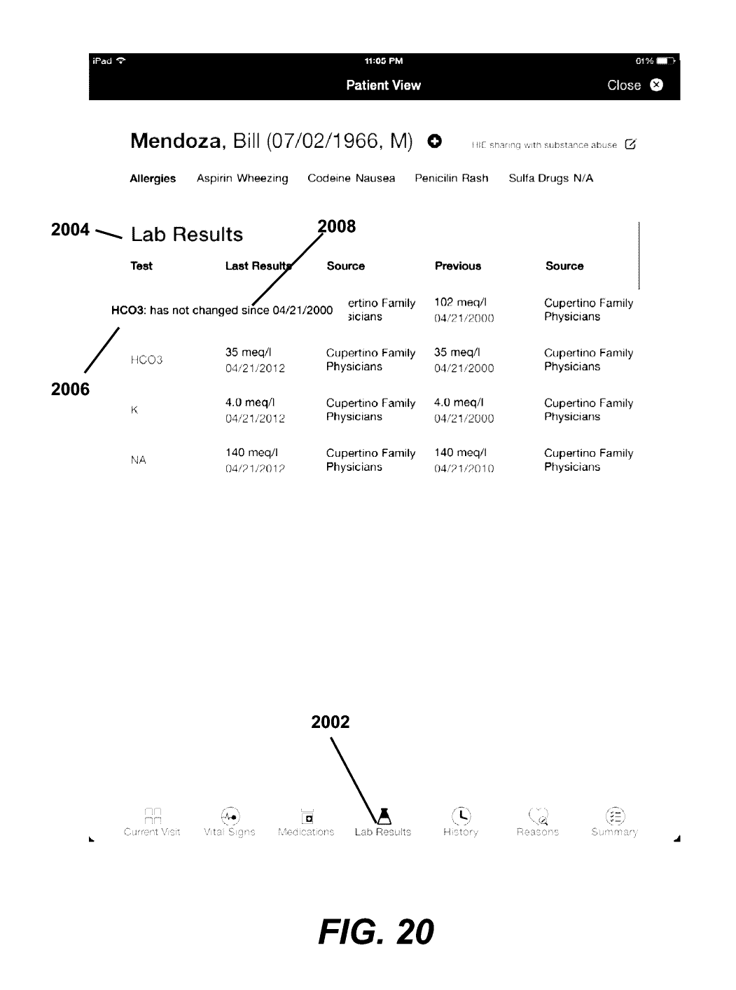

A patient's lab results history may be displayed in an embodiment of the invention in a manner similar to the display of medications described above. As is illustrated in the exemplary embodiment of FIG. 20, a user may select a “lab results” menu selection 2002 to display a history of lab test results 2004. As with the display of medications illustrated earlier, an embodiment of the invention may be configured to permit a user to scroll up or down through lab results data. In addition, a user may select a particular test result to view additional information from that particular test. An example of this is illustrated at 2006. As is shown, a user may select a particular lab result for additional data or comments 2008 associate with the lab test results.

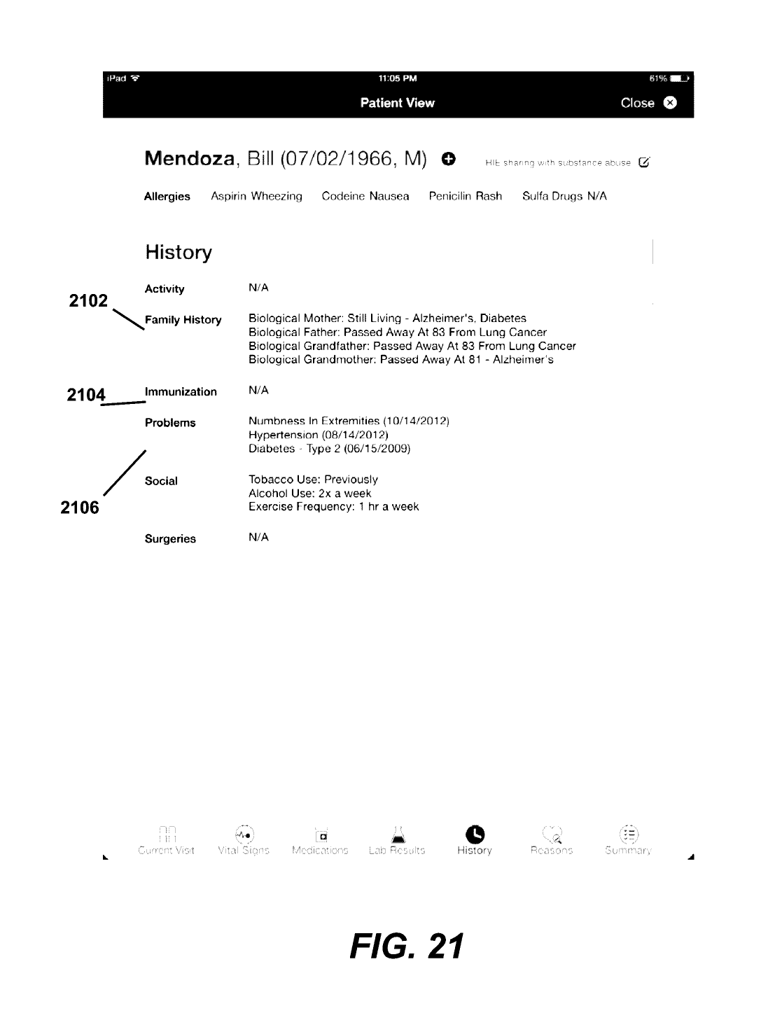

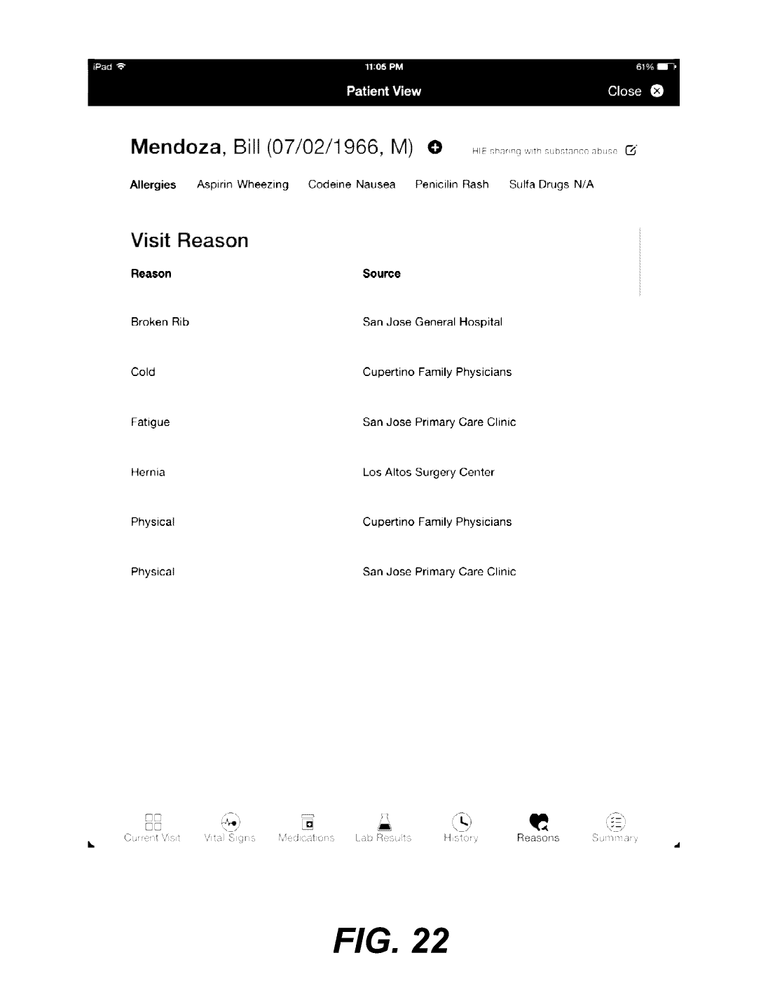

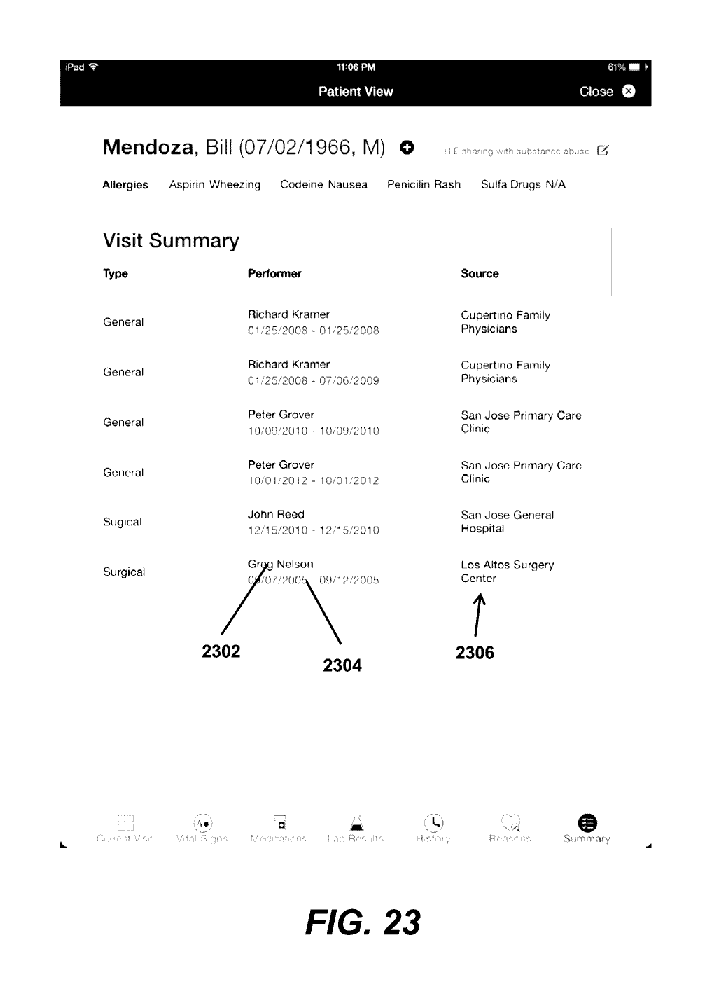

In addition to medication and lab results, a physician or care provider may also review a patient's history in order to identify trends in a patient or patient's family history that may indicate a particular disease or condition for which the patient may be more susceptible. An example embodiment of a user interface to display such history is illustrated in FIG. 21. As is shown, such patient history may include family history 2102, immunization records 2104, past patient health problems 2106, patient characteristics such as family history, occupation, level of exercise, alcohol and tobacco use, and past surgical procedures. Other historical information presented by an embodiment of the invention may include patient health complaints (reasons for visits to one or more care providers). FIG. 22 illustrates a user interface which summarizes the reasons for a patient's visit to a plurality of different care providers. FIG. 23 shows a user interface which displays a visit summary for past patient visits. In addition to a brief description of the visit, such an embodiment may also display the physician or care provider 2302, a date of service 2304, and the location at which the service was provided 2306. As is illustrated, such a summary may include information from several sources. Prior to the present invention, a care provider may have had to rely on a patient to self-report visits to other care providers.

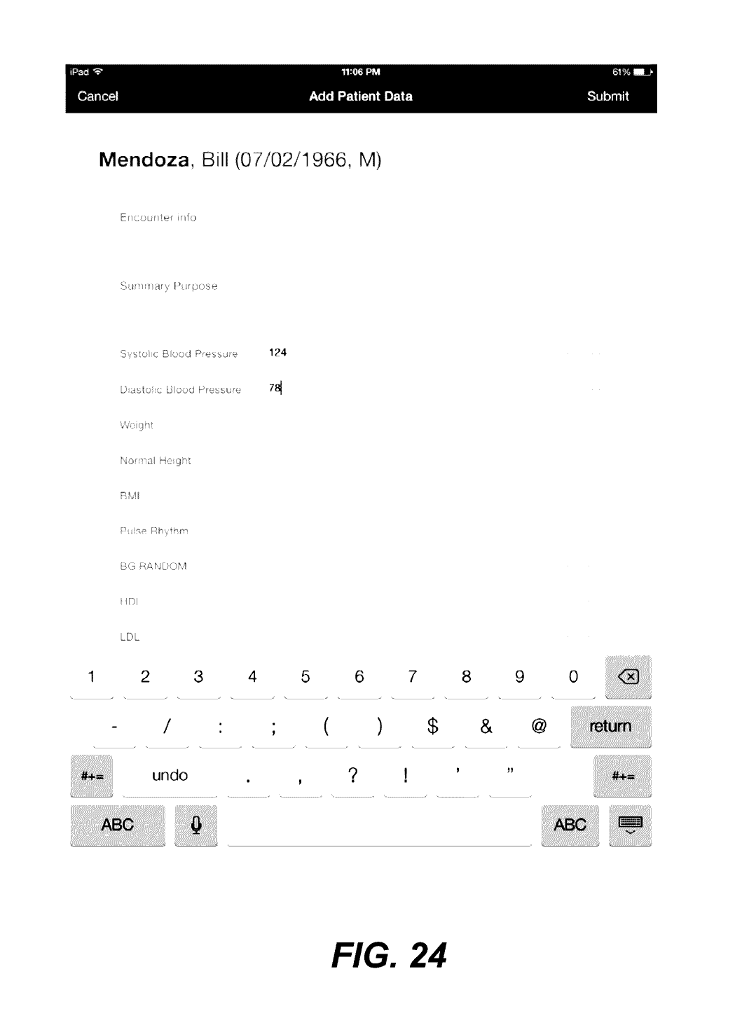

As was the case with the alternate user interface generated by an interface appliance device 202 and illustrated in FIG. 10, a mobile application (App) which provides a user an interface from a mobile device such as a tablet computer to a interface appliance device 202 may be configured to enable a user to input patient data into the EMR system directly from the mobile device. An example of such an interface is illustrated in FIG. 24. Such a capability may allow a physician or caregiver to enter a patient's information directly into a mobile computer device during a patient visit. In addition to time savings, this capability may facilitate analysis from a health analytics engine, as described below, to operate on the most current patient data.

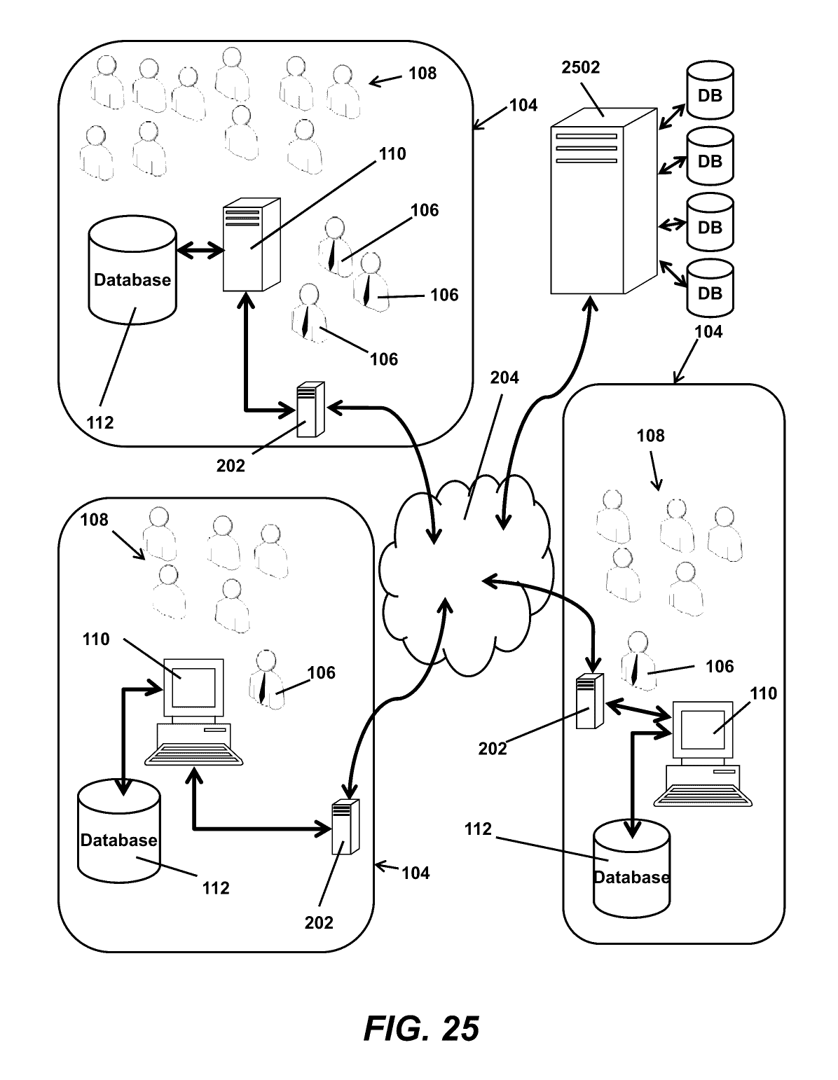

In addition to embodiments of the invention as illustrated in FIG. 2, other embodiments of the invention may comprise a plurality of EMR systems, a plurality of interface appliance devices, and at least one medical analytics engine. As is illustrated in FIG. 25, such an embodiment may be comprised of a health analytics engine 2502, a wide area network, such as the internet 204, and plurality of interface appliances devices 202 in communication with EMR systems associated with care providers 104. The medical analytics engine 2502 shown is illustrated as a computer server. In addition to embodiments configured using computer servers as illustrated, in certain embodiments of the invention such a medical analytics engine may be formed using virtual computing technology. Virtual computing is often referred to as cloud computing. In such an embodiment, a medical analytics engine may be accessed by an interface appliance device 202 via a function call to a virtual computer server executing software instructions that cause the virtual server to perform health analytics engine functions as if it were an actual computer server.

A health analytics engine 2502 may be in communication with one or more patient records databases. In addition to information available from EMR systems in communication with the analytics engine, these patient records databases may comprise patient records derived from insurance claim information, patient complaints, and preauthorization requests. In addition to such records, the health analytics engine 2502 may be in communication with databases that comprise treatment protocols, treatment effectiveness analytics, recommended care schedules, and formularies. Using data contained in these databases, the health analytics engine generate drug to drug interaction warnings, drug to disease interaction warnings, gap in care alerts, provide corroboration of current diagnoses, provide treatment recommendations based on diagnosed conditions, and calculate a patient's cumulative exposure to X-rays. Prior to embodiments of the invention which may retrieve data from a plurality of EMR systems, generation of such warnings and information relied upon the care provider to inquire about care or treatments received by the patient from other providers. Such information is frequently inaccurate and as such, the corresponding analysis results may be suspect.

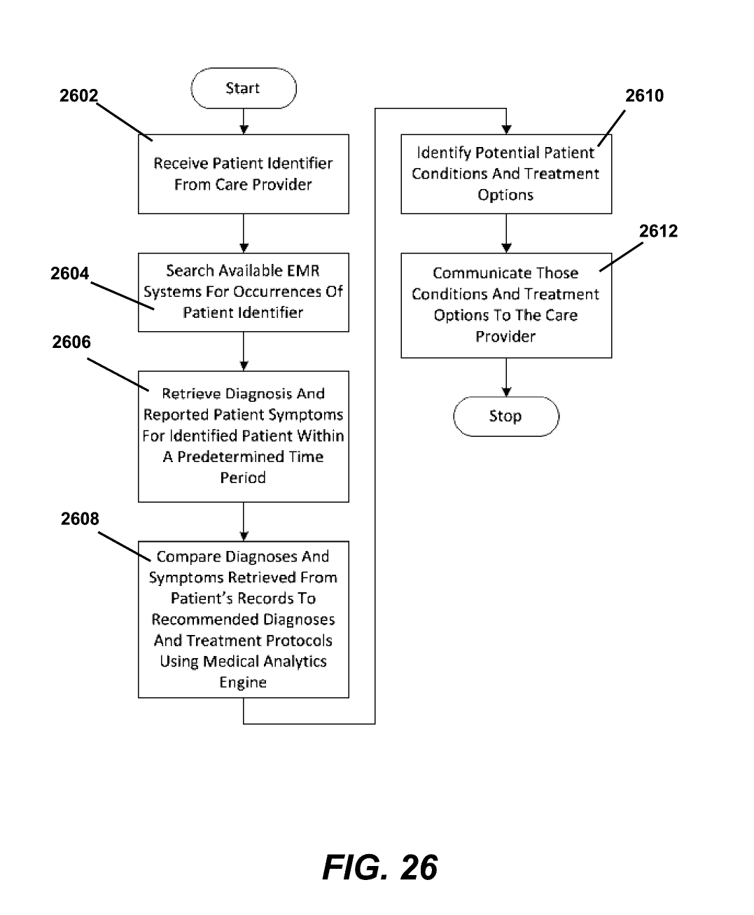

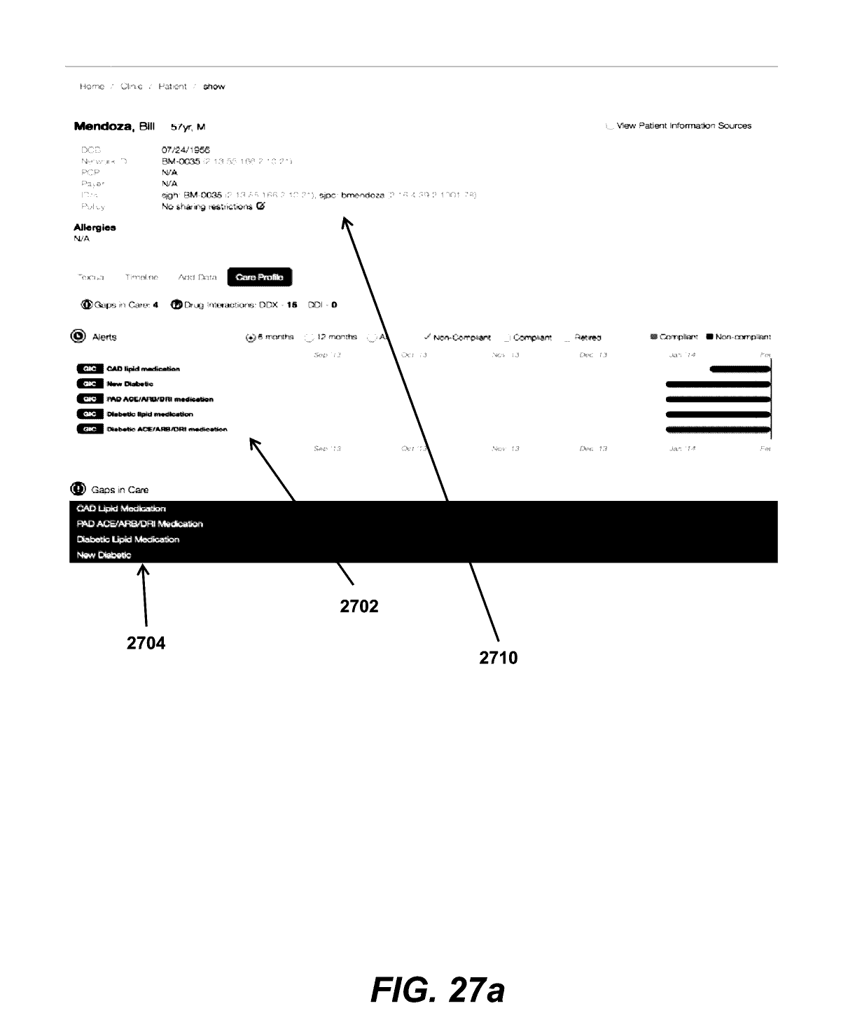

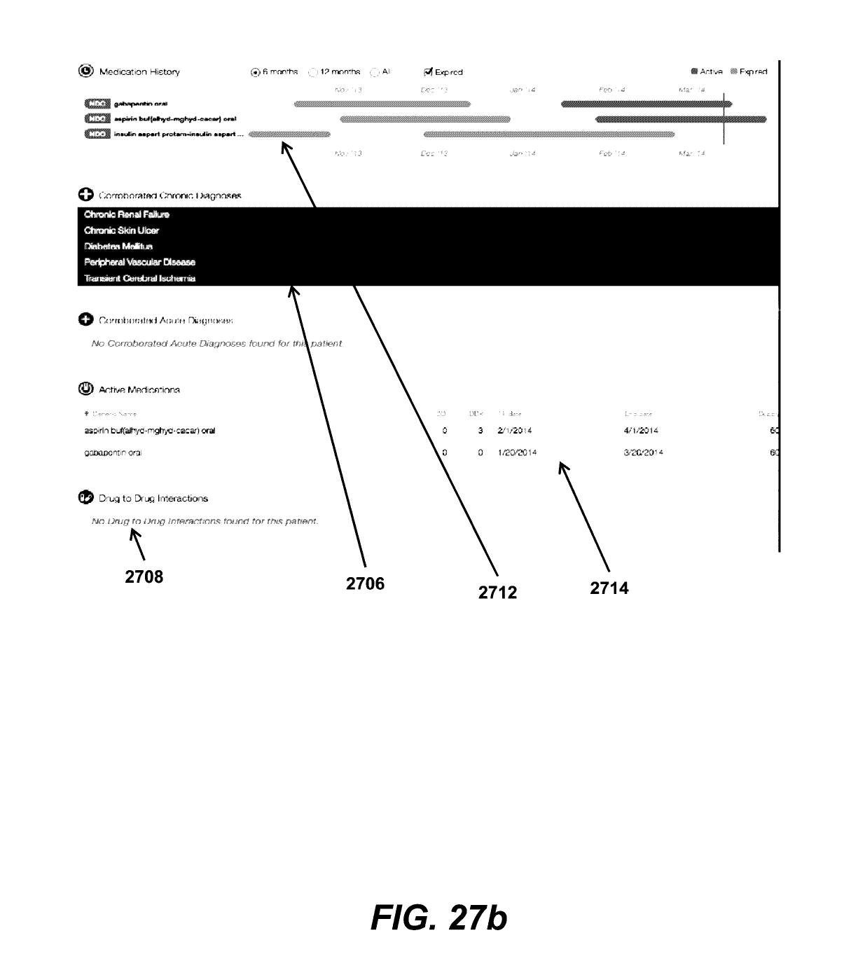

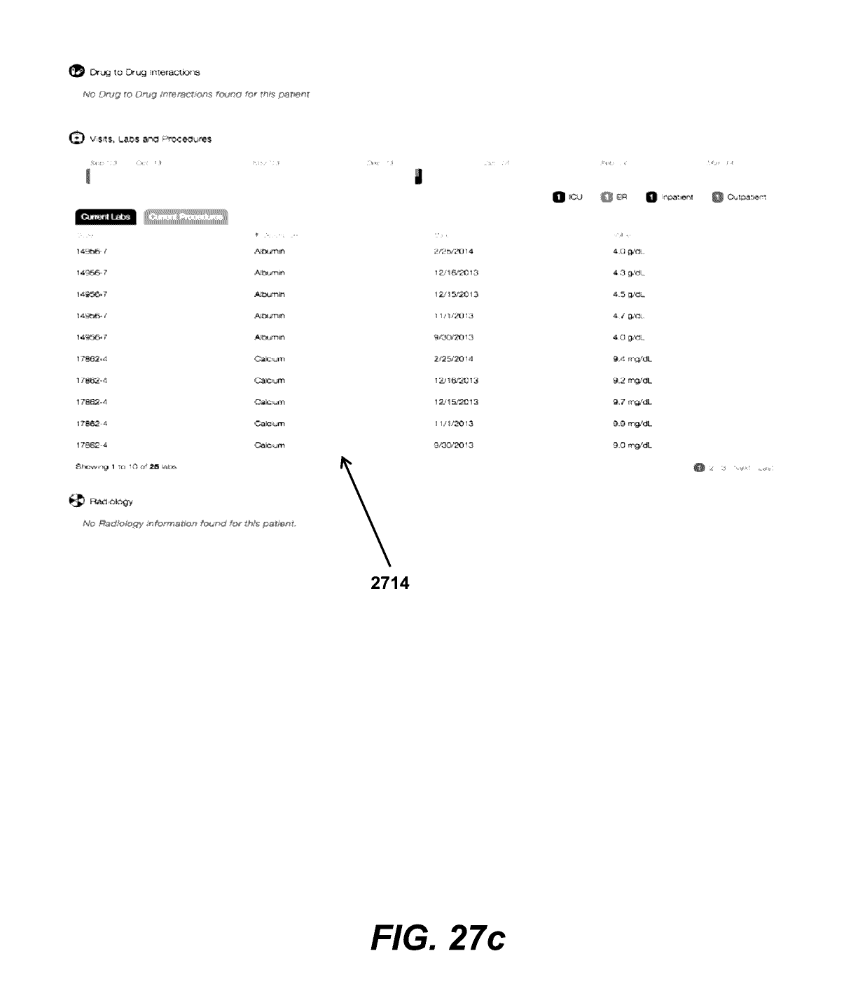

Combining health analytics engine functionality with the interface appliances 202 may allow the health analytics engine to analyze a patient's condition based upon a more complete picture of that patient's characteristics and symptoms. This is because, like the patient data presented to care providers in the user interfaces illustrated in the previous figures, a health analytics engine in an embodiment of the invention may be able to access patient data from a plurality of EMR systems. An example of why this is an improvement over known methods is illustrated by an example of the detection of a drug on drug interaction. In such an example, the analytics engine 2502 may retrieve patient prescription information from a first EMR system and additional patient prescription information from a second EMR system. In an exemplary embodiment, the analytics engine may determine from a drug interaction database that prescription “A” identified in the first EMR system may have a potentially harmful interaction with prescription “B” identified in the second EMR system. Referring to the flowchart of FIG. 26, which illustrates an exemplary process steps performed by an analytics engine to process information from a plurality of EMR systems in communication with the analytics engine through the use of interface appliances 202. In the illustrated example, an analytics engine receives a patient identifier from a heath care provider 2602. Using this patient identifier, the analytics engine may search available EMR systems for occurrences of the patient identifier 2604. Available EMR systems are those systems in communication with the analytics engine 2502 via interface appliances 202 as illustrated in FIG. 25. This step may be similar to the search illustrated in FIG. 5. When occurrences have been identified, an embodiment of the invention may retrieve diagnosis and reported patient symptoms from patient records associated with the patient at each EMR system 2606. The analytics engine may compare the retrieved patient diagnoses and symptoms to recommended diagnoses and treatment protocols that may be contained in databases associated with the analytics engine 2608. In step 2610, diagnoses and treatment protocols are identified that correspond to past patient diagnoses and symptoms. These identified diagnoses and symptoms may be reported to the care provider in step 2612. As was noted above, the health analytics engine may identify other patient conditions using similar steps, retrieving patient information from connected EMR systems and then reporting the potential conditions and concerns to a care provider. An example of such reporting is illustrated in FIGS. 27a-27c. As is illustrated, an exemplary interface may comprise alerts 2702, gaps in care 2704, possible patient diagnoses 2706, and drug interactions 2708. As is illustrated, a user interface may be configured to provide basic patient information 2710, medication information 2712, and patient care history information 2714.

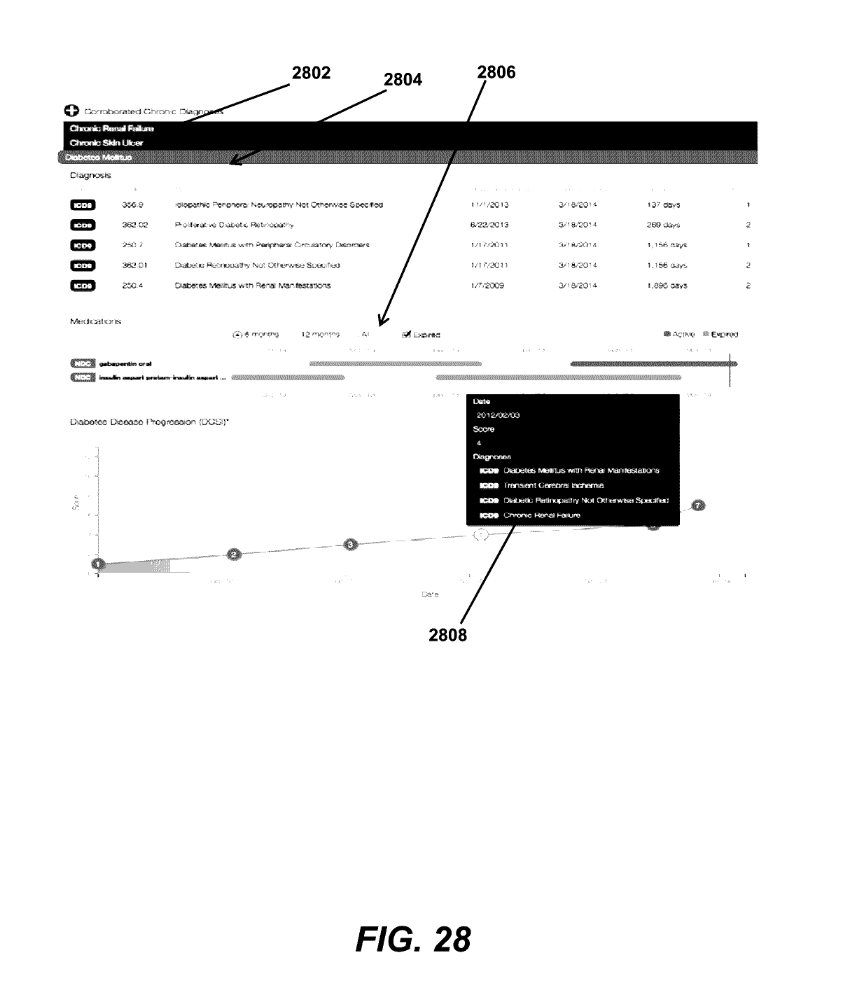

In certain embodiments of the invention, a care provider may obtain a summary of the patient information used by the analytics engine to identify a potential patient health condition. In such embodiments, a care provider may select a possible diagnoses provided by the analytics engine and be presented with a user interface or report comprised of the patient information used to identify the possible diagnoses. An example of such a report is illustrated in FIG. 28 where the selected possible diagnoses 2802 includes the diagnosis 2804 and medication history 2806 used by the analytics engine 2502 to produce the indicated possible diagnosis 2802. Should the care provider wish to receive additional information, the care provider may select portions of the displayed data to obtain such addition information. For example, as is shown in FIG. 28, a care provider has selected one of the data points on a disease progression chart to view additional information about that data point 2808. In embodiments of the invention that provide a care provider user interface using a portable computer devices such as a tablet computer, a care provider may receive and view analytics engine information in real or near real-time during a patient visit. For example, a care provider may be meeting with a patient to examine that patient and provide care. As the care provider examines the patient and enters characteristics of the patient's condition into the portable computer, the computer may communicate that information to an interface appliance 202, which may be in communication with an analytics engine 2502. As was described in the flowchart of FIG. 26, the analytics engine 2502 may identify potential conditions, gaps in care, drug interactions, or other health concerns and communicate those issues back to the interface appliance 202 for communication to the portable computer used by the care provider. As a result, the care provider may often receive and have the opportunity to review any identified concerns and take steps to mitigate risks before the patient leaves the care provider's facility. An example of this may be the receipt of a drug interaction warning that is presented when a care provider enters information related to a prescribed drug into an embodiment of the invention. In such an embodiment of the invention, the warning may reduce the inconvenience to a patient that may occur when the patient attempts to fill the prescription at a pharmacy. Perhaps more important than inconvenience, such a warning may prevent a drug interaction from occurring should the pharmacist not have the information from the prior prescription.

In addition to making treatment recommendations specifically targeted towards a particular patient's condition during a visit to a care provider, embodiments of the invention may also collect data from a plurality of EMR systems and use such data to generate population health data. Such data represents characteristics of the population comprised by the various patients whose data is contained in one or more of the plurality of EMR systems. Population health data may be used to provide a baseline or other measure of comparison to evaluate compliance against expected outcomes for care providers where such expected outcomes may be defined by healthcare standards proffered by governmental agencies, employers, or health insurance providers. Such data may be further refined to identify those patient populations that are most at risk of being out of compliance. By analyzing such information, care providers may be able to identify patient population areas that are at risk of not receiving recommended levels of patient care.

Many health care providers provide care services to patients who receive such care as the result of programs such as Medicare and Medicaid. These and other care programs, both governmental and private, have begun to implement programs designed to ensure that care provided to patients is both effective and economical. These programs generally entail an application of care rules and standards that are based upon an aggregate of care applied to a population segment. Examples of such standards comprise meaningful use (of care) standards including those administered by the Centers for Medicare and Medicaid Services (CMS) and the U.S. Department of Health and Human Services. These standard themselves comprise sets of performance standards applicable to certain diseases and heath conditions. Care providers are required or strongly encouraged to comply with these standards and failure to comply may result in a loss of funding or patient referrals. Embodiments of the invention may be configured to monitor the care received by patients whose medical care records are contained in one or more of the plurality of EMR systems in communication of interface appliance devices 202. As was described earlier, embodiments of the invention may retrieve patient heath record data from a first interface appliance device 202 as well as from the EMR system in communication with a second interface appliance device 202. In an embodiment of the invention which monitors patient care to ensure compliance with care standards, an analytics engine 2502 may have access to a collection of such care standards and may execute software instructions to compare the care received by a patient or group of patients to that care required by the standard.

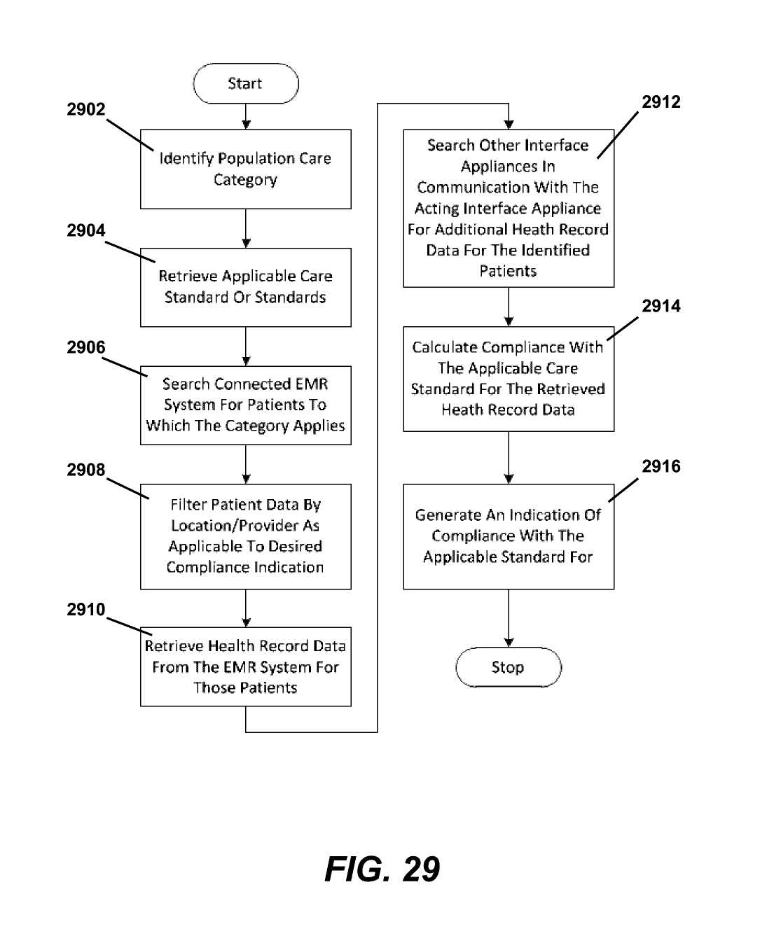

Referring to the flow chart of FIG. 29, in an embodiment of the invention a user may identify a population care category for which the user wishes to receive an indication of compliance. For example, a user may wish to understand how well a care provider location is succeeding in the treatment of patients with diabetes with regard to a particular standard. In such an example, the user may identify all patients with a diagnosis of diabetes who receive care at a general care practice and perform an analysis of the level of care that these patients received to determine whether that care meets the required standards. In step 2902, the user selects diabetes care as the population category. Examples of other conditions may include arthritis, emphysema, or pregnancy. An analytics engine may retrieve the applicable standard of care from a database or other storage location 2904. In step 2906, the analytics engine may search the EMR system that is associated with the general care practice to identify patients with the diagnoses or condition to which the standard applies. In the present example, an embodiment of the invention may search for and identify patients who have been diagnosed with diabetes. Embodiments of the invention may be configured to allow a user to filter the results of a search by various patient groups 2908 in order to determine whether such groups are receiving a level of care that is in compliance with the applicable standard. For example, a user may wish to identify all patients receiving care for diabetes at a practice location. In another example, a user may wish to limit the patients analyzed to those receiving care from a particular caregiver. In addition, certain embodiments of the invention may be configured to analyze data for a single patient. In such an embodiment, additional care standards may be applied to the patient in order to determine whether the patient is receiving a level of care that satisfies standards applicable to that patient. Such an embodiment may be particularly useful when a patient is in the process of visiting a care provider in order to receive health care. In such a situation, a care provider may cause an analysis to be performed and as a result of that analysis, determine that there are areas for which a patient is at risk of not meeting a standard of care. Because the patient may be in the care provider's office at the moment, the care provider may make adjustments to that patient's care to mitigate such risks while that patient is still in the care provider's office. Once such patients have been identified, an embodiment of the invention may retrieve health record data for those patient from the EMR system associated with a particular care provider (in the present example, a general care provider) 2910. In step 2912, those interface appliances in communication with the network to which the interface appliance 202 is connected are also searched to identify electronic medical record data for the identified patients. As was described earlier herein, this data may be combined with patient data retrieved from a first EMR system to generate a temporary patient health record that is used by the health analytics engine to generate a compliance indication. In step 2914, the analytics engine 2502 may calculate the level of compliance to the care standard retrieved in step 2904. Once the level of compliance has been calculated, an indication of compliance level may be communicated to the user in a user interface 2916. In addition to level of compliance, embodiments of the invention may also provide the user with an indication of the particular circumstances which resulted in the level of compliance indicated. In an instance where the level of compliance required has not been met, an embodiment of the invention may provide suggestions to the user that, if followed, may result in meeting the standard's requirements. Such an embodiment may be particularly useful to a care provider when providing care to a patient whose care has thus far failed to comply with the required standards. In such an instance, the care provider may review the data provided by an embodiment of the invention and attempt to improve the level of care received. Other embodiments of the invention may provide an indication of compliance in the form of alerts, performance reports, or compliance dashboards.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A computerized system for analyzing and presenting compliance to care standards, comprising:
A medical data analytics engine;
at least one care standards database in communication with the analytics engine, comprising health care compliance standards;
a first electronic interface appliance in communication with a first electronic medical records system comprising a first patient's data in a first format, said interface appliance including:
(a) a communication interface that exchanges information with a second electronic interface appliance where said second additional interface appliance is in communication with a second electronic medical records system comprising medical data for said first patient in a different format from said first format;
(b) a processor in communication with the first electronic medical records system, the second electronic interface appliance, and the medical analytics engine, that executes software instructions to:
(i) retrieve said first patient's data from the first electronic medical records system;
(ii) analyze the received first patient data;
(iii) retrieve said first patient's data from said second electronic interface appliance;
(iv) provide said patient data to the medical analytics engine and cause the medical analytics engine to compare a performed care recorded in said patient data to health care compliance standards; and
(v) communicate the results of said comparison to the user of the first electronic interface appliance.

2. The computerized system of claim 1, where the software instructions executed by the processor to cause the medical analytics engine to compare the performed care, further comprises steps to:
receive an input selection from a user comprised of the selection of a predefined category of patient characteristics; and
cause the processor to calculate a level of compliance to at least one health care compliance standard for patient records identified by the selected category of patient characteristics.

3. The computerized system of claim 2, wherein the input selection comprises a patient identifier.

4. The computerized system of claim 2, wherein the input selection comprises at least one selection from the group: care provider identifier; care location identifier; patient diagnoses; and patient behaviors.

5. The computerized system of claim 1, wherein the software instructions executed by the processor to cause the medical analytics engine to determine the compliance of performed care, additionally comprises steps to:
Identify medical care needed to bring said patient into compliance with at least one health care standard.

6. The computerized system of claim 3, where the processor further executes software instructions comprising steps to:
identify compliance standards for which the selected patient's data fails to comply.

7. The computerized system of claim 6, where the processor further executes software instructions comprising steps to:
calculate actions needed to bring care received by the selected patient into compliance with the identified medical standards; and
provide the user of the first electronic interface appliance an indication of the actions needed.

8. The computerized system of claim 3, where the processor further executes software instructions comprising steps to:
analyze the patient data indicated by the received patient identifier to identify patient characteristics;
receive an input selection from the user selecting at least one of the identified patient characteristics;
analyze the patient data received for patients other than the identified patient to determine the average level of compliance to standards applicable to the patient characteristic(s) selected;
analyze the patient data received for the identified patient to determine the level of compliance to standards applicable to the patient characteristic(s) selected;
calculate the level of compliance for the identified patient compared to the determined average level of compliance; and
provide the user of the first electronic interface appliance a listing of the calculated levels of compliance for the identified patient.

9. The computerized system of claim 8, where the processor further executes software instructions comprising steps to provide the user of the first electronic interface appliance an indication of the medical care actions needed to bring the identified patient into compliance with the average level of compliance.

10. The computerized system of claim 4, where the processor further executes software instructions comprising steps to:
identify compliance standards for which the patient data identified by the input selection fails to comply.

11. The computerized system of claim 10, where the processor further executes software instructions comprising steps to:
calculate medical care actions needed to bring care received by the patient data identified by the input selection into compliance with the identified medical standards; and
provide the user of the first electronic interface appliance an indication of the medical care actions needed.

12. A computerized method of analyzing and presenting health care standards compliance information derived from a plurality of electronic medical record systems, at least one analytics engine in communication with health care compliance standards, to a user comprising the steps of:
receiving, at a first electronic interface appliance, patient data from a first electronic medical records system comprising patient data in a first format;
analyzing the received patient data;
receiving, at the first electronic interface appliance, patient data from at least one additional electronic interface appliance;
processing at an analytics engine, the received data to calculate the compliance of the received data to health care compliance standards; and
communicating the calculated compliance of the received data to a user of the first interface appliance.

13. The computerized method of claim 12, wherein the step of communicating the compliance of the received data to health care compliance standards comprises the step of presenting the calculated compliance in a predefined user interface.

14. The computerized method of claim 12, further comprising the steps of:
receiving an input at the first electronic interface appliance from a user of the first electronic interface appliance, comprised of the selection of a predefined category of patient characteristics; and
calculating the level of compliance to at least one health care compliance standard for patient records identified by the selected category of patient characteristics.

15. The computerized method of claim 14, wherein the received input comprises a patient identifier.

16. The computerized method of claim 14, wherein the received input comprises at least one selection from a list comprising: care provider identifier; care location identifier; patient diagnoses; and patient behaviors.

17. The computerized method of claim 12, where step of calculating the compliance of the received data to health care compliance standards also comprises the step of calculating medical care needed to bring one or more patients into compliance with medical standards used by the analytics engine to perform compliance analysis.

18. The computerized method of claim 15, where step of calculating the compliance of the received data to health care compliance standards also comprises the step of identifying compliance standards for which the selected patient's data fails to comply.

19. The computerized method of claim 18, where the step of calculating the compliance of the received data to health care compliance standards also comprises calculating the medical care actions needed to bring care received by the selected patient into compliance with health care compliance standards.

20. The computerized method of claim 16, where step of calculating the compliance of the received data to health care compliance standards also comprises the step of identifying compliance standards for which patient data identified by the received input fails to comply.

21. The computerized method of claim 20, where the step of calculating the compliance of the received data to health care compliance standards also comprises calculating the medical care actions needed to bring care received by the patients whose data is identified by the received input into compliance with health care compliance standards.

22. A computerized system for analyzing and presenting the compliance to care standards of patient electronic health records from a plurality of electronic health record systems, comprised of:
an analytics engine;
at least one database in communication with the analytics engine, comprising health care compliance standards;
a first electronic interface appliance in communication with a first electronic medical records system comprising patient data in a first format, said interface appliance comprising:
(a) a communication interface that exchanges information with at least one additional electronic interface appliance where each additional appliance is in communication with an electronic medical records system comprising data in a different format from the first format;
(b) a processor in communication with the first electronic medical records system, the additional electronic interface appliance(s), and the medical analytics engine, that executes software instructions to:
(i) receive patient data from the first electronic medical records system;
(ii) retrieve patient data from at least one additional electronic interface appliance;
(iii) receive an input selection from a user comprised of at least one selection from a list comprising: patient identifier; care provider identifier; care location identifier; patient diagnoses; and patient behaviors;
(iv) provide the patient data to the medical analytics engine and cause the medical analytics engine to calculate the compliance of received care, recorded in patient data identified by the received input selection, to at least one health care compliance standard;
(v) identify health care compliance standards for which the identified patient data fails to comply;
(vi) calculate medical care actions needed to bring care received by the selected patient into compliance with the identified health care standards; and
(vii) communicate the results of the compliance analysis, the identified standards for which patient data fails to comply, and the medical actions needed to bring the patient care into compliance with the health care standards, to a user of the first interface appliance.
